(19) United States
(12) Patent Application Publication
(10) Pub. No.: US 2024/0302504 A1
(43) Pub. Date: Sep. 12, 2024

(54) PHOTODETECTION DEVICE AND PHOTODETECTION SYSTEM

(71) Applicant: SONY SEMICONDUCTOR SOLUTIONS CORPORATION, KANAGAWA (JP)

(72) Inventors: TAKAFUMI TAKATSUKA, KANAGAWA (JP); YASUJI IKEDA, KANAGAWA (JP); YUSUKE OIKE, KANAGAWA (JP)

(21) Appl. No.: 18/254,707

(22) PCT Filed: Oct. 19, 2021
(86) PCT No.: PCT/JP2021/038568

§ 371 Date: May 26, 2023

(30) Foreign Application Priority Data
Dec. 4, 2020 (JP) 2020-202130

(51) Int. Cl. G01S 7/4863; G01S 7/487; G01S 17/894

(52) U.S. Cl. CPC G01S 7/4863; G01S 7/4873; G01S 17/894

(57) ABSTRACT

A photodetection device according to the present disclosure includes: one or a plurality of light-receiving sections that each includes a light-receiving element, and generates a pulse signal including a pulse corresponding to a result of light reception by the light-receiving element; a plurality of first counters that each performs count processing on the basis of one or a plurality of the pulse signals generated by the one or plurality of light-receiving sections, thereby generating a plurality of count values; and a subtraction processor that performs subtraction processing for subtracting a predetermined value from each of the plurality of count values, on the basis of one or more count values of the plurality of count values.

### TECHNICAL FIELD

The present disclosure relates to a photodetection device and a photodetection system that detect light.

### BACKGROUND ART

A TOF (Time OF Flight) method is frequently used to measure a distance to an detection object. In this TOF method, light is emitted, and reflected light reflected by the detection object is detected. Then, in the TOF method, the distance to the measurement object is measured by measuring a time difference between a timing at which the light is emitted and a timing at which the reflected light is detected. For example, PTL 1 discloses a distance measuring device that reduces a light reception amount of ambient light by turning off any of a plurality of light-receiving elements.

### CITATION LIST

### Patent Literature

PTL 1: Japanese Unexamined Patent Application Publication No. 2014-77658

### SUMMARY OF THE INVENTION

In a photodetection device, it is desired to enhance detection accuracy, and a further improvement in detection accuracy is expected.

It is desirable to provide a photodetection device and a photodetection system that make it possible to enhance detection accuracy.

A first photodetection device according to an embodiment of the present disclosure includes one or a plurality of light-receiving sections, a plurality of first counters, and a subtraction processor. The one or plurality of light-receiving sections each includes a light-receiving element, and is configured to generate a pulse signal including a pulse corresponding to a result of light reception by the light-receiving element. The plurality of first counters is configured to each perform count processing on the basis of one or a plurality of the pulse signals generated by the one or plurality of light-receiving sections, thereby generating a plurality of count values. The subtraction processor is configured to perform subtraction processing for subtracting a predetermined value from each of the plurality of count values, on the basis of one or more count values of the plurality of count values.

A second photodetection device according to an embodiment of the present disclosure includes one or a plurality of light-receiving sections, a plurality of first counters, a stop processor, and a threshold setting section. The one or plurality of light-receiving sections each includes a light-receiving element, and is configured to generate a pulse signal including a pulse corresponding to a result of light reception by the light-receiving element. The plurality of first counters is configured to each perform count processing on the basis of one or a plurality of the pulse signals generated by the one or plurality of light-receiving sections, thereby generating a plurality of count values. The stop controller is configured to stop the count processing in the plurality of first counters in a case where one or more count values of the plurality of count values have reached a first threshold. The threshold setting section is configured to make a change to increase the first threshold on the basis of one or more count values of the plurality of count values.

A first photodetection system according to an embodiment of the present disclosure includes a light-emitting section and a photodetector. The light-emitting section is configured to emit light. The photodetector is configured to detect light reflected by a detection object of the light emitted from the light-emitting section. This photodetector includes one or a plurality of light-receiving sections, a plurality of first counters, and a subtraction processor. The one or plurality of light-receiving sections each includes a light-receiving element, and is configured to generate a pulse signal including a pulse corresponding to a result of light reception by the light-receiving element. The plurality of first counters is configured to each perform count processing on the basis of one or a plurality of the pulse signals generated by the one or plurality of light-receiving sections, thereby generating a plurality of count values. The subtraction processor is configured to perform subtraction processing for subtracting a predetermined value from each of the plurality of count values, on the basis of one or more count values of the plurality of count values.

A second photodetection system according to an embodiment of the present disclosure includes a light-emitting section and a photodetector. The light-emitting section is configured to emit light. The photodetector is configured to detect light reflected by a detection object of the light emitted from the light-emitting section. This photodetector includes one or a plurality of light-receiving sections, a plurality of first counters, a stop processor, and a threshold setting section. The one or plurality of light-receiving sections each includes a light-receiving element, and is configured to generate a pulse signal including a pulse corresponding to a result of light reception by the light-receiving element. The plurality of first counters is configured to each perform count processing on the basis of one or a plurality of the pulse signals generated by the one or plurality of light-receiving sections, thereby generating a plurality of count values. The stop controller is configured to stop the count processing in the plurality of first counters in a case where one or more count values of the plurality of count values have reached a first threshold. The threshold setting section is configured to make a change to increase the first threshold on the basis of one or more count values of the plurality of count values.

In the first photodetection device and the first photodetection system according to the embodiments of the present disclosure, the one or plurality of light-receiving sections each generates the pulse signal including a pulse corresponding to a result of light reception by the light-receiving element. The plurality of first counters each performs count processing on the basis of one or a plurality of the pulse signals generated by the one or plurality of light-receiving sections, thereby generating a plurality of count values. The subtraction processor performs subtraction processing for subtracting a predetermined value from each of the plurality of count values CNT, on the basis of one or more count values of the plurality of count values.

In the second photodetection device and the second photodetection system according to the embodiments of the present disclosure, the one or plurality of light-receiving sections each generates the pulse signal including a pulse corresponding to a result of light reception by the light-receiving element. The plurality of first counters each performs count processing on the basis of one or a plurality of the pulse signals generated by the one or plurality of light-receiving sections, thereby generating a plurality of count values. The stop controller stops the count processing in the plurality of first counters in a case where one or more count values of the plurality of count values have reached a first threshold. The threshold setting section makes a change to increase the first threshold on the basis of one or more count values of the plurality of count values.

### BRIEF DESCRIPTION OF DRAWINGS

FIG. 1 is a block diagram illustrating a configuration example of a photodetection system according to an embodiment of the present disclosure.

FIG. 2 is a block diagram illustrating a configuration example of a photodetector illustrated in FIG. 1.

FIG. 3 is a circuit diagram illustrating a configuration example of a photodetection unit illustrated in FIG. 2.

FIG. 4A is a circuit diagram illustrating a configuration example of a light-receiving section illustrated in FIG. 3.

FIG. 4B is a circuit diagram illustrating another configuration example of the light-receiving section illustrated in FIG. 3.

FIG. 5 is a block diagram illustrating a configuration example of a subtraction determining section illustrated in FIG. 3.

FIG. 6 is a block diagram illustrating a configuration example of a saturation determining section illustrated in FIG. 3.

FIG. 7 is a timing waveform diagram illustrating an operation example of the photodetection unit illustrated in FIG. 3.

FIG. 8 is an explanatory diagram illustrating changes in count values in the photodetection unit illustrated in FIG. 3.

FIG. 9 is a flowchart illustrating an operation example of the photodetector illustrated in FIG. 2.

FIG. 10 is an explanatory diagram illustrating an operation example of a signal processor illustrated in FIG. 2.

FIG. 11 is an explanatory diagram illustrating an operation example of the photodetection unit illustrated in FIG. 3.

FIG. 12A is a circuit diagram illustrating a configuration example of a light-receiving section according to a modification example of a first embodiment.

FIG. 12B is a circuit diagram illustrating a configuration example of the light-receiving section according to the modification example of the first embodiment.

FIG. 13 is a circuit diagram illustrating a configuration example of a photodetection unit according to another modification example of the first embodiment.

FIG. 14 is a circuit diagram illustrating a configuration example of a photodetection unit according to another modification example of the first embodiment.

FIG. 15 is a circuit diagram illustrating a configuration example of a light-receiving section illustrated in FIG. 14.

FIG. 16 is an explanatory diagram illustrating an operation example of a subtraction controller according to another modification example of the first embodiment.

FIG. 17 is a circuit diagram illustrating a configuration example of a photodetection unit according to another modification example of the first embodiment.

FIG. 18 is a circuit diagram illustrating a configuration example of a subtraction determining section illustrated in FIG. 17.

FIG. 19 is a timing waveform diagram illustrating an operation example of the photodetection unit illustrated in FIG. 17.

FIG. 20 is a circuit diagram illustrating a configuration example of a photodetection unit according to another modification example of the first embodiment.

FIG. 21 is a circuit diagram illustrating a configuration example of a subtraction determining section illustrated in FIG. 20.

FIG. 22 is a circuit diagram illustrating another configuration example of the subtraction determining section illustrated in FIG. 20.

FIG. 23 is a circuit diagram illustrating a configuration example of a photodetection unit according to another modification example of the first embodiment.

FIG. 24 is a timing waveform diagram illustrating an operation example of the photodetection unit illustrated in FIG. 23.

FIG. 25 is another timing waveform diagram illustrating an operation example of the photodetection unit illustrated in FIG. 23.

FIG. 26 is an explanatory diagram illustrating an implementation example of a photodetector according to another modification example of the first embodiment.

FIG. 27 is a circuit diagram illustrating a configuration example of a light-receiving section according to another modification example of the first embodiment.

FIG. 28 is an explanatory diagram illustrating an implementation example of a photodetector according to another modification example of the first embodiment.

FIG. 29 is a block diagram illustrating a configuration example of a photodetection system according to another modification example of the first embodiment.

FIG. 30 is a block diagram illustrating a configuration example of a photodetector illustrated in FIG. 29.

FIG. 31 is a circuit diagram illustrating a configuration example of a photodetection unit illustrated in FIG. 30.

FIG. 32 is a block diagram illustrating a configuration example of a photodetector according to a second embodiment.

FIG. 33 is a circuit diagram illustrating a configuration example of a photodetection unit illustrated in FIG. 32.

FIG. 34 is an explanatory diagram illustrating an operation example of the photodetection unit illustrated in FIG. 33.

FIG. 35 is an explanatory diagram illustrating an example of deviation of time (TOF).

FIG. 36 is a block diagram illustrating a configuration example of a photodetector according to a modification example of the second embodiment.

FIG. 37 is a circuit diagram illustrating a configuration example of a photodetection unit illustrated in FIG. 36.

FIG. 38 is an explanatory diagram illustrating an operation example of a light reception amount image generator illustrated in FIG. 36.

FIG. 39 is a circuit diagram illustrating a configuration example of a photodetection unit according to another modification example of the second embodiment.

FIG. 40 is a block diagram illustrating a configuration example of a photodetector according to another modification example of the second embodiment.

FIG. 41 is a circuit diagram illustrating a configuration example of a photodetection unit illustrated in FIG. 40.

FIG. 42 is a block diagram illustrating a configuration example of a photodetector according to a third embodiment.

FIG. 43 is a circuit diagram illustrating a configuration example of a photodetection unit illustrated in FIG. 42.

FIG. 44 is an explanatory diagram illustrating changes in count values in the photodetection unit illustrated in FIG. 43.

FIG. 45 is a flowchart illustrating an operation example of the photodetector illustrated in FIG. 42.

FIG. 46 is a circuit diagram illustrating a configuration example of a photodetection unit according to a fourth embodiment.

FIG. 47 is an explanatory diagram illustrating changes in count values in the photodetection unit illustrated in FIG. 46.

FIG. 48 is a flowchart illustrating an operation example of a photodetector according to the fourth embodiment.

FIG. 49 is a block diagram depicting an example of schematic configuration of a vehicle control system.

FIG. 50 is a diagram of assistance in explaining an example of installation positions of an outside-vehicle information detecting section and an imaging section.

### MODES FOR CARRYING OUT THE INVENTION

In the following, some embodiments of the present disclosure are described in detail with reference to the drawings. It is to be noted that description is given in the following order.
1. First Embodiment
2. Second Embodiment
3. Third Embodiment
4. Fourth Embodiment
5. Example of Application to Mobile Body

### 1. First Embodiment

### Configuration Example

FIG. 1 illustrates a configuration example of a photodetection system (photodetection system 1) according to an embodiment. The photodetection system 1 is a ToF (Time-of-Flight) sensor, and is configured to emit light and detect reflected light reflected by a detection object OBJ. The photodetection system 1 includes a light-emitting section 11, an optical system 12, a photodetector 20, and a controller 14.

The light-emitting section 11 is configured to emit a light pulse L0 toward the detection object OBJ on the basis of an instruction from the controller 14. The light-emitting section 11 emits the light pulse L0 on the basis of an instruction from the controller 14 by performing a light emission operation of alternately repeating emission and non-emission of light. The light-emitting section 11 includes, for example, a light source that emits infrared light. This light source is configured with use of, for example, a laser light source, an LED (Light Emitting Diode), or the like.

The optical system 12 includes a lens that forms an image on a light-receiving surface S of the photodetector 20. A light pulse (reflected light pulse L1) emitted from the light-emitting section 11 and reflected by the detection object OBJ enters this optical system 12.

The photodetector 20 is configured to detect the reflected light pulse L1 on the basis of an instruction from the controller 14. The photodetector 20 then generates a distance image on the basis of a detection result, and outputs image data of the generated distance image as data DT.

The controller 14 is configured to supply control signals to the light-emitting section 11 and the photodetector 20 and control operations of the light-emitting section 11 and the photodetector 20 to thereby control an operation of the photodetection system 1.

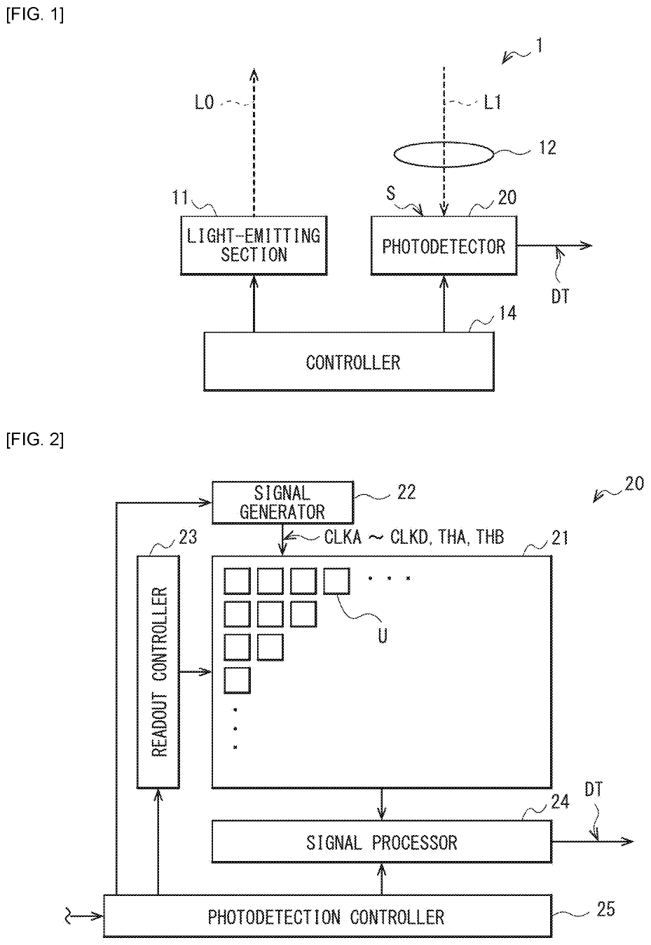

FIG. 2 illustrates a configuration example of the photodetector 20. The photodetector 20 includes a photodetection array 21, a signal generator 22, a readout controller 23, a signal processor 24, and a photodetection controller 25.

The photodetection array 21 includes a plurality of photodetection units U disposed in a matrix. The photodetection units U are each configured to detect the reflected light pulse L1 and count the number of detection times of the reflected light pulse L1.

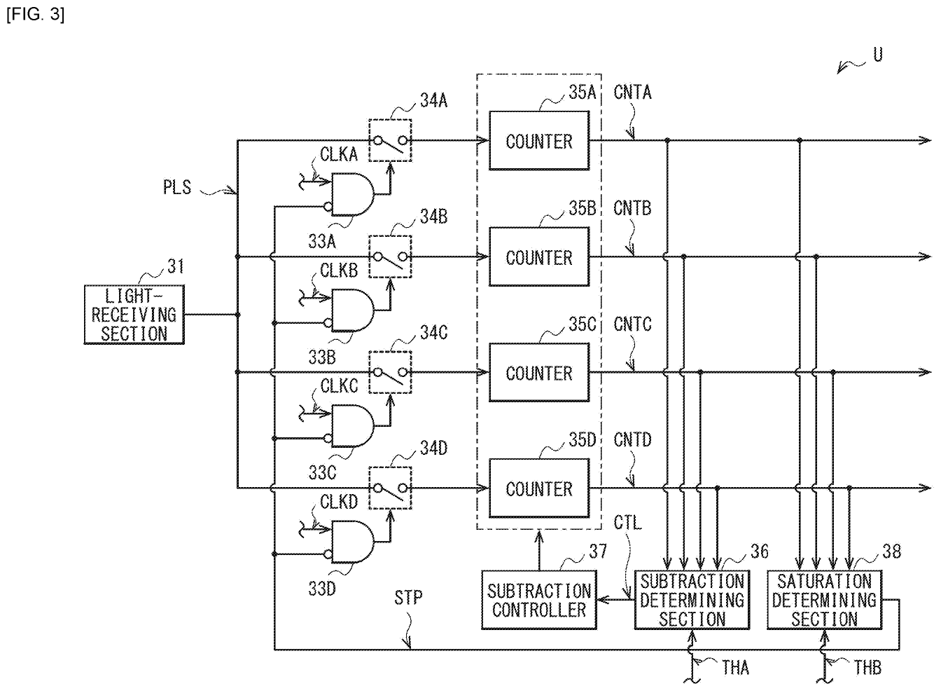

FIG. 3 illustrates a configuration example of the photodetection unit U. The photodetection unit U includes a light-receiving section 31, a plurality of logical AND (AND) circuits 33 (four AND circuits 33A to 33D in this example), a plurality of switches 34 (four switches 34A to 34D in this example), a plurality of counters 35 (four counters 35A to 35D in this example), a subtraction determining section 36, a subtraction controller 37, and a saturation determining section 38. It is to be noted that, in this example, four circuits including the AND circuit 33, the switch 34, and the counter 35 are provided, but this is not limitative. For example, three or more circuits including the AND circuit 33, the switch 34, and the counter 35 may be provided.

The light-receiving section 31 is configured to detect light to thereby generate a pulse signal PLS including a pulse corresponding to the detected light.

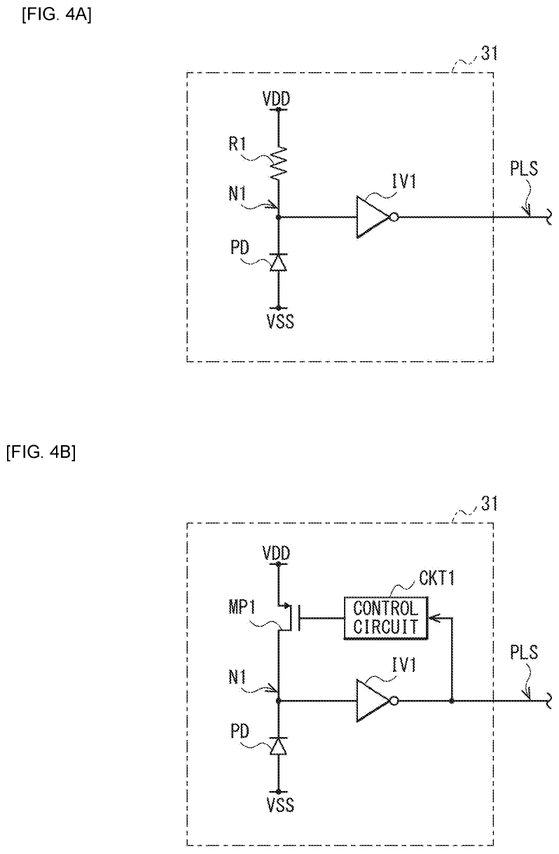

FIG. 4A illustrates a configuration example of the light-receiving section 31. In this example, the light-receiving section 31 includes a photodiode PD, a resistor R1, and an inverter IV1.

The photodiode PD is a photoelectric conversion element that converts light into electric charge. The photodiode PD has an anode supplied with a power supply voltage VSS, and a cathode coupled to a node N1. It is possible to use, for example, an avalanche photodiode (APD; Avalanche Photodiode), a single photon avalanche diode (SPAD; Single Photon Avalanche Diode), or the like for the photodiode PD.

The resistor R1 has one end supplied with a power supply voltage VDD, and another end coupled to the node N1.

The inverter IV1 is configured to output a low level in a case where a voltage at the node N1 is higher than a logical threshold, and output a high level in a case where the voltage at the node N1 is lower than the logical threshold to thereby generate the pulse signal PLS.

With this configuration, in the light-receiving section 31, the photodiode PD causes avalanche amplification by detecting light, which decreases the voltage at the node N1. Then, in a case where the voltage at the node N1 becomes lower than the logical threshold of the inverter IV1, the pulse signal PLS changes from the low level to the high level. Thereafter, a current flows into the node N1 through the resistor R1 to thereby increase the voltage at the node N1. Then, in a case where the voltage at the node N1 becomes higher than the logical threshold of the inverter IV1, the pulse signal PLS changes from the high level to the low level. Thus, the light-receiving section 31 generates the pulse signal PLS including a pulse corresponding to the detected light.

FIG. 4B illustrates another configuration example of the light-receiving section 31. In this example, the light-receiving section 31 includes the photodiode PD, a transistor MP1, the inverter IV1, and a control circuit CKT1.

The transistor MP1 is a P-type MOS (Metal Oxide Semiconductor) transistor, and has a gate coupled to an output terminal of the control circuit CKT1, a source supplied with the power supply voltage VDD, and a drain coupled to the node N1.

The control circuit CKT1 is configured to control an operation of the transistor MP1 on the basis of the pulse signal PLS. Specifically, the control circuit CKT1 changes a voltage at the gate of the transistor MP1 to the low level after the pulse signal PLS changes from the low level to the high level, and changes the voltage at the gate of the transistor MP1 to the high level after the pulse signal PLS changes from the high level to the low level.

With this configuration, in the light-receiving section 31, the photodiode PD detects light to thereby decrease the voltage at the node N1. Then, in a case where the voltage at the node N1 becomes lower than the logical threshold of the inverter IV1, the pulse signal PLS changes from the low level to the high level. After this change in the pulse signal PLS, the control circuit CKT1 changes the voltage at the gate of the transistor MP1 to the low level. This turns on the transistor MP1 to cause a current to flow into the node N1 through the transistor MP1, which increases the voltage at the node N1. Then, in a case where the voltage at the node N1 becomes higher than the logical threshold of the inverter IV1, the pulse signal PLS changes from the high level to the low level. After this change in the pulse signal PLS, the control circuit CKT1 changes the voltage at the gate of the transistor MP1 to the high level. This turns off the transistor MP1. Thus, the light-receiving section 31 generates the pulse signal PLS including a pulse corresponding to the detected light.

The AND circuit 33A (FIG. 3) is configured to find logical AND of a clock signal CLKA and an inverted signal of a control signal STP. The switch 34A is configured to turn on or off supply of the pulse signal PLS to the counter 35A on the basis of an output signal of the AND circuit 33A. Specifically, the switch 34A supplies the pulse signal PLS to the counter 35A in a case where the output signal of the AND circuit 33A is at the high level, and supplies a low-level signal to the counter 35A in a case where the output signal of the AND circuit 33A is at the low level. The switch 34A is configured with use of, for example, an AND circuit or a logical OR (OR) circuit.

Likewise, the AND circuit 33B is configured to find logical AND of a clock signal CLKB and the inverted signal of the control signal STP. The switch 34B is configured to turn on or off supply of the pulse signal PLS to the counter 35B on the basis of an output signal of the AND circuit 33B. The AND circuit 33C is configured to find logical AND of a clock signal CLKC and the inverted signal of the control signal STP. The switch 34C is configured to turn on or off supply of the pulse signal PLS to the counter 35C on the basis of an output signal of the AND circuit 33C. The AND circuit 33D is configured to find logical AND of a clock signal CLKD and the inverted signal of the control signal STP. The switch 34D is configured to turn on or off supply of the pulse signal PLS to the counter 35D on the basis of an output signal of the AND circuit 33D.

The counter 35A is configured to increment a count value CNTA by performing count processing on the basis of a rising edge of the pulse signal supplied from the switch 34A. Likewise, the counter 35B is configured to increment a count value CNTB by performing count processing on the basis of a rising edge of the pulse signal supplied from the switch 34B. The counter 35C is configured to increment a count value CNTC by performing count processing on the basis of a rising edge of the pulse signal supplied from the switch 34C. The counter 35D is configured to increment a count value CNTD by performing count processing on the basis of a rising edge of the pulse signal supplied from the switch 34D.

The subtraction determining section 36 is configured to generate a control signal CTL by determining whether or not all of the count values CNTA to CNTD have reached a threshold THA. In other words, the subtraction determining section 36 generates the control signal CTL by determining whether or not the smallest value among the count values CNTA to CNTD has reached the threshold THA.

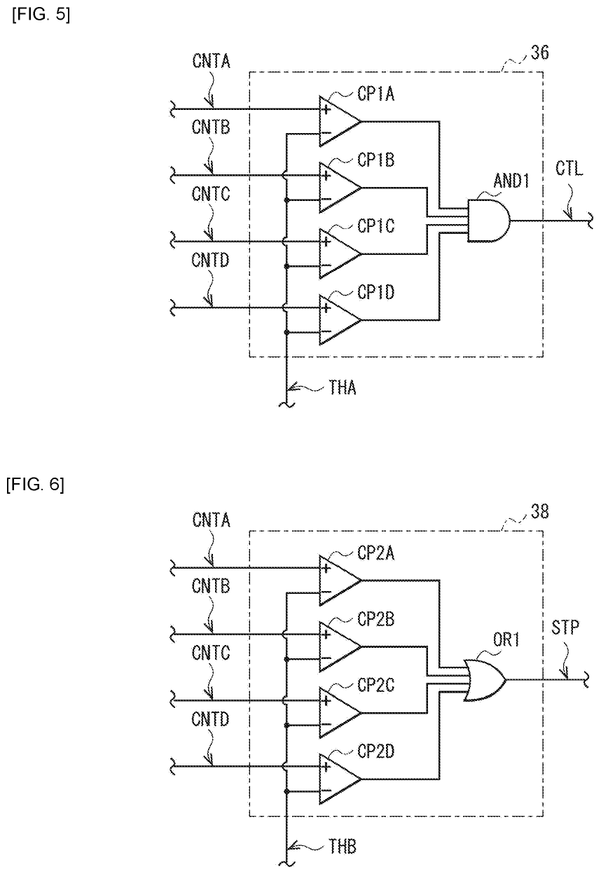

FIG. 5 illustrates a configuration example of the subtraction determining section 36. The subtraction determining section 36 includes comparator circuits CP1A, CP1B, CP1C, and CP1D, and an AND circuit AND1. The comparator circuit CP1A is configured to determine whether or not the count value CNTA is larger than the threshold THA. The comparator circuit CP1B is configured to determine whether or not the count value CNTB is larger than the threshold THA. The comparator circuit CP1C is configured to determine whether or not the count value CNTC is larger than the threshold THA. The comparator circuit CP1D is configured to determine whether or not the count value CNTD is larger than the threshold THA. The AND circuit AND1 is configured to generate the control signal CTL by finding logical AND of an output signal of the comparator circuit CP1A, an output signal of the comparator circuit CP1B, an output signal of the comparator circuit CP1C, and an output signal of the comparator circuit CP1D. This configuration allows the subtraction determining section 36 to determine whether or not all of the count values CNTA to CNTD have reached the threshold THA.

The subtraction controller 37 (FIG. 3) is configured to subtract a predetermined value from each of the count values CNTA to CNTD in the counters 35A to 35D on the basis of a determination result of the subtraction determining section 36.

The saturation determining section 38 is configured to generate the control signal STP by determining whether or not one or more count values of the count values CNTA to CNTD have reached a threshold THB. Specifically, the saturation determining section 38 changes the control signal STP to the high level in a case where one or more count values of the count values CNTA to CNTD have reached the threshold THB, and changes the control signal STP to the low level in a case where none of the count values CNTA to CNTD has reached the threshold THB. The threshold THB is set at a value larger than the threshold THA.

FIG. 6 illustrates a configuration example of the saturation determining section 38. The saturation determining section 38 includes comparator circuits CP2A, CP2B, CP2C, and CP2D, and an OR circuit OR1. The comparator circuit CP2A is configured to determine whether or not the count value CNTA is larger than the threshold THB. The comparator circuit CP2B is configured to determine whether or not the count value CNTB is larger than the threshold THB. The comparator circuit CP2C is configured to determine whether or not the count value CNTC is larger than the threshold THB. The comparator circuit CP2D is configured to determine whether or not the count value CNTD is larger than the threshold THB. The OR circuit OR1 is configured to generate the control signal STP by finding logical OR of an output signal of the comparator circuit CP2A, an output signal of the comparator circuit CP2B, an output signal of the comparator circuit CP2C, and an output signal of the comparator circuit CP2D. This configuration allows the saturation determining section 38 to determine whether or not one or more count values of the count values CNTA to CNTD have reached the threshold THB.

In a case where the saturation determining section 38 determines that one or more count values of the count values CNTA to CNTD have reached the threshold THB and changes the control signal STP to the high level, each of the AND circuits 33A to 33D changes the output signal to the low level. Accordingly, the switches 34A to 34D stop supply of the pulse signal PLS to the counters 35A to 35D, and the counters 35A to 35D stop count processing.

The signal generator 22 (FIG. 2) is configured to generate the clock signals CLKA to CLKD and the thresholds THA and THB on the basis of an instruction from the photodetection controller 25 and supply the clock signals CLKA to CLKD and the thresholds THA and THB to the plurality of photodetection units U in the photodetection array 21.

The readout controller 23 is configured to control an operation of supplying, to the signal processor 24, the count values CNTA to CNTD generated in each of the plurality of photodetection units U in the photodetection array 21, on the basis of an instruction from the photodetection controller 25. For example, the readout controller 23 controls operations of the plurality of photodetection units U to sequentially select the photodetection units U for one row, and cause the selected photodetection units U to supply the count values CNTA to CNTD to the signal processor 24.

The signal processor 24 is configured to generate a distance image on the basis of an instruction from the photodetection controller 25. Specifically, the signal processor 24 generates a distance image by measuring time (TOF value) from emission of the light pulse L0 by the light-emitting section 11 to detection of the reflected light pulse L1 by the photodetection unit U, on the basis of the count values CNTA to CNTD supplied from each of the plurality of photodetection units U. The signal processor 24 then outputs image data of the generated distance image as the data DT.

The photodetection controller 25 is configured to control the operation of the photodetector 20 on the basis of an instruction from the controller 14 (FIG. 1) by supplying control signals to the signal generator 22, the readout controller 23, and the signal processor 24 and controlling operations of the signal generator 22, the readout controller 23, and the signal processor 24.

Here, the light-receiving section 31 corresponds to a specific example of a “light-receiving section” in the present disclosure. The photodiode PD corresponds to a specific example of a “light-receiving element” in the present disclosure. The pulse signal PLS corresponds to a specific example of a “pulse signal” in the present disclosure. The switches 34A to 34D correspond to specific examples of a “divider” in the present disclosure. The counter 35 corresponds to a specific example of a “counter” in the present disclosure. The subtraction determining section 36 and the subtraction controller 37 correspond to specific examples of a “subtraction processor” in the present disclosure. The saturation determining section 38 and the AND circuits 33A to 33D correspond to specific examples of a “stop processor” in the present disclosure. The signal processor 24 corresponds to a specific example of a “first processor” in the present disclosure. The threshold THB corresponds to a specific example of a “first threshold” in the present disclosure. The threshold THA corresponds to a specific example of a “second threshold” in the present disclosure.

### Operation and Workings

Next, the operation and workings of the photodetection system 1 according to the present embodiment are described.

### (Overview of Overall Operation)

First, an overview of the overall operation of the photodetection system 1 is described with reference to FIGS. 1 and 2. The light-emitting section 11 emits the light pulse L0 toward the detection object OBJ. The optical system 12 forms an image on the light-receiving surface S of the photodetector 20. The photodetector 20 detects the reflected light pulse L1. The controller 14 supplies control signals to the light-emitting section 11 and the photodetector 20 and controls operations of the light-emitting section 11 and the photodetector 20 to thereby control a distance measuring operation of the photodetection system 1.

In the photodetector 20, the photodetection units U of the photodetection array 21 each generate the count values CNTA to CNTD by detecting the reflected light pulse L1. The signal generator 22 generates the clock signals CLKA to CLKD and the thresholds THA and THB, and supplies the clock signals CLKA to CLKD and the thresholds THA and THB to the plurality of photodetection units U. The readout controller 23 controls an operation of supplying, to the signal processor 24, the count values CNTA to CNTD generated in each of the plurality of photodetection units U in the photodetection array 21. The signal processor 24 generates a distance image on the basis of the count values CNTA to CNTD supplied from the plurality of photodetection units U in the photodetection array 21 and outputs image data of the generated distance image as the data DT. The photodetection controller 25 controls the operation of the photodetector 20 on the basis of an instruction from the controller 14 by supplying control signals to the signal generator 22, the readout controller 23, and the signal processor 24 and controlling the operations of the signal generator 22, the readout controller 23, and the signal processor 24.

### (Detailed Operation)

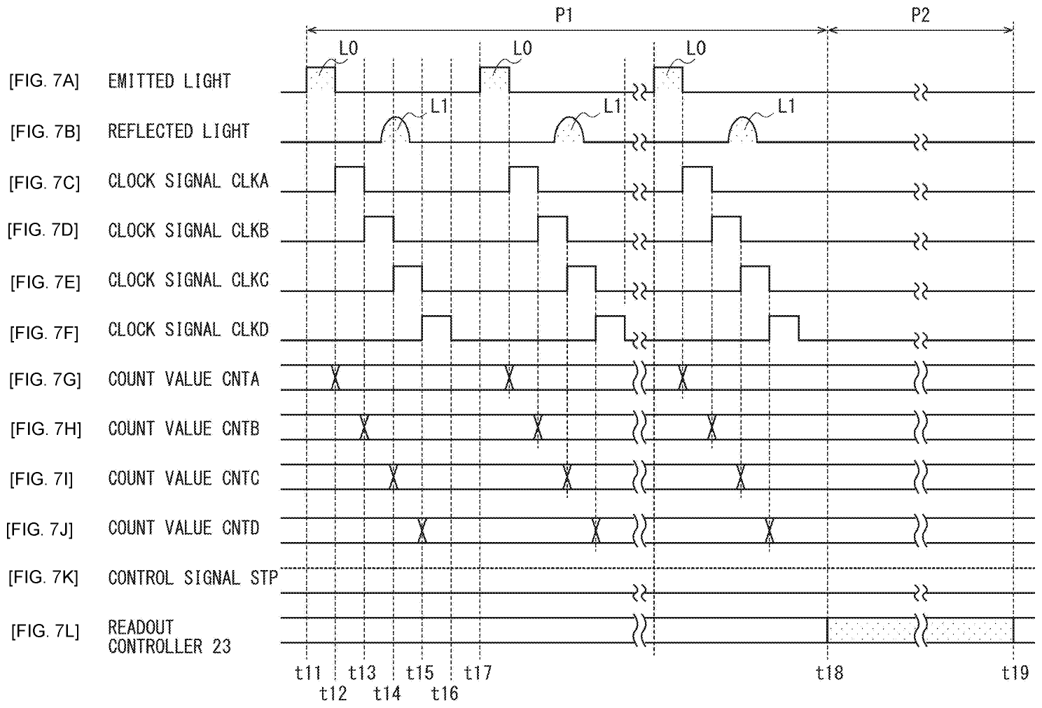

FIG. 7 illustrates an operation example of the photodetector 20. (A) indicates a waveform of light emitted from the light-emitting section 11. (B) indicates a waveform of light reflected by the detection object OBJ and having entered a certain photodetection unit U. (D) to (F) respectively indicate waveforms of the clock signals CLKA to CLKD. (G) to (J) respectively indicate waveforms of the count values CNTA to CNTD. (K) indicates a waveform of the control signal STP. (L) indicate an operation of the readout controller 23.

In a period (exposure period P1) from a timing t11 to a timing t18, the photodetection system 1 repeatedly emits the light pulse L0, and repeatedly detects the reflected light pulse L1 reflected by the detection object OBJ.

Specifically, in a period from the timing t11 to a timing t12, the light-emitting section 11 emits light ((A) of FIG. 7). The signal generator 22 changes the clock signal CLKA to the high level in a period from the timing t12 to a timing t13, changes the clock signal CLKB to the high level in a period from the timing t13 to a timing t14, changes the clock signal CLKC to the high level in a period from the timing t14 to a timing t15, and changes the clock signal CLKD to the high level in a period from the timing t15 to a timing t16 ((C) to (F) of FIG. 7). In this example, the reflected light pulse L1 is generated in a period in which the clock signal CLKB is changed to the high level and a period in which the clock signal CLKC is changed to the high level ((B) of FIG. 7). None of the count values CNTA to CNTD has not reached the threshold THB, and the control signal STP is at the low level ((K) of FIG. 7). Accordingly, the switch 34A supplies the pulse signal PLS to the counter 35A in the period from the timing t12 to the timing t13, the switch 34B supplies the pulse signal PLS to the counter 35B in the period from the timing t13 to the timing t14, the switch 34C supplies the pulse signal PLS to the counter 35C in the period from the timing t14 to the timing t15, and the switch 34D supplies the pulse signal PLS to the counter 35D in the period from the timing t15 to the timing t16. Thus, the switches 34A to 34D distribute the pulse signal PLS to the counters 35A to 35D in a time division manner on the basis of the clock signals CLKA to CLKD.

In the period from the timing t12 to the timing t13, the counter 35A performs count processing on the basis of a rising edge of the pulse signal PLS supplied from the switch 34A to increment the count value CNTA ((G) of FIG. 7). Likewise, in the period from the timing t13 to the timing t14, the counter 35B performs count processing on the basis of a rising edge of the pulse signal PLS supplied from the switch 34B to increment the count value CNTB ((H) of FIG. 7). In the period from the timing t14 to the timing t15, the counter 35C performs count processing on the basis of a rising edge of the pulse signal PLS supplied from the switch 34C to increment the count value CNTC ((I) of FIG. 7). In the period from the timing t15 to the timing t16, he counter 35D performs count processing on the basis of a rising edge of the pulse signal PLS supplied from the switch 34D to increment the count value CNTD ((J) of FIG. 7).

The photodetection unit U repeats such an operation from the timing t11 to a timing t17. Accordingly, the counter 35A performs count processing in a plurality of periods in which the clock signal CLKA is at the high level to generate the count value CNTA, the counter 35B performs count processing in a plurality of periods in which the clock signal CLKB is at the high level to generate the count value CNTB, the counter 35C performs count processing in a plurality of periods in which the clock signal CLKC is at the high level to generate the count value CNTC, and the counter 35D performs count processing in a plurality of periods in which the clock signal CLKD is at the high level to generate the count value CNTD.

Then, in a period (readout period P2) from the timing t18 to a timing t19, the readout controller 23 performs readout control CR, thereby controlling the operations of the plurality of photodetection units U to supply, to the signal processor 24, the count values CNTA to CNTD generated by each of the plurality of photodetection units U ((L) of FIG. 7). Thereafter, the count values CNTA to CNTD in the counters 35A to 35D are reset.

As illustrated in FIG. 7, in a case where the photodetection unit U detects the reflected light pulse L1 in a period in which the clock signal CLKB is at the high level and a period in which the clock signal CLKC is at the high level, the count value CNTB and the CNTC include a component (reflected light component C1) corresponding to reflected light.

In addition to the reflected light illustrated in (B) of FIG. 7, ambient light also enters the photodetector 20. The ambient light may enter the photodetector 20 in all of a period in which the clock signal CLKA is at the high level, a period in which the clock signal CLKB is at the high level, a period in which the clock signal CLKC is at the high level, and a period in which the clock signal CLKC is at the high level. Accordingly, the count values CNTA to CNTD each include a component (ambient light component C2) corresponding to the ambient light. The amount of this ambient light component C2 is substantially equal in the count values CNTA to CNTD.

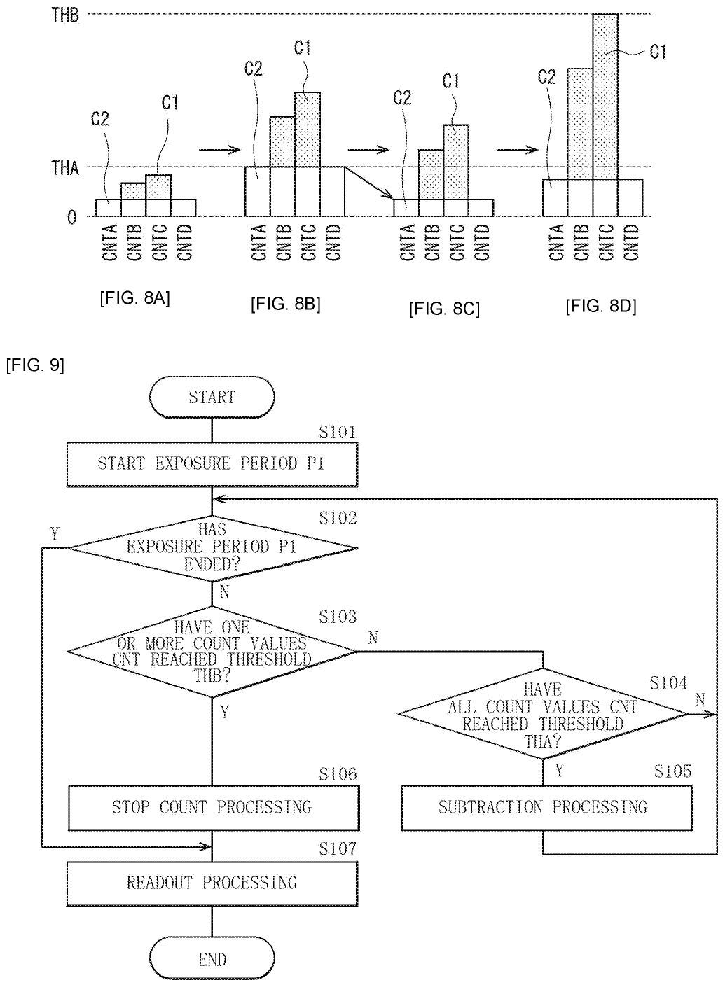

FIG. 8 illustrates an example of changes in the count values CNTA to CNTD in the exposure period P1. A shaded portion indicates the reflected light component C1, and a white portion indicates the ambient light component C2. As described above, the count values CNTB and CNTC each include the reflected light component C1 and the ambient light component C2, and the count values CNTA and CNTD each include the ambient light component C2.

When the exposure period P1 starts, the count values CNTA to CNTD gradually increase with the lapse of time. At a timing illustrated in (A) of FIG. 8, the ambient light component C2 in each of the count values CNTA to CNTD is smaller than the threshold THA.

Thereafter, at a timing illustrated in (B) of FIG. 8, the ambient light component C2 in each of the count values CNTA to CNTD reaches the threshold THA. The subtraction determining section 36 determines that all of the count values CNTA to CNTD have reached the threshold THA. In other words, the subtraction determining section 36 determines that the smallest value among the count values CNTA to CNTD has reached the threshold THA. Accordingly, the subtraction controller 37 subtracts a predetermined value from each of the count values CNTA to CNTD ((C) of FIG. 8). Thus, a portion of the ambient light component C2 in each of the count values CNTA to CNTD is removed, and the reflected light component C1 is maintained.

Even after that, the count values CNTA to CNTD gradually increase with the lapse of time.

Then, at a timing illustrated in (D) of FIG. 8, the count value CNTC reaches the threshold THB. The saturation determining section 38 determines that one or more count values of the count values CNTA to CNTD have reached the threshold THB, and changes the control signal STP from the low level to the high level. The AND circuits 33A to 33D each change the output signal to the low level on the basis of this control signal STP. Accordingly, the switches 34A to 34D stop supply of the pulse signal PLS to the counters 35A to 35D, and the counters 35A to 35D stop count processing. That is, in a case where one or more count values of the count values CNTA to CNTD have reached the threshold THB, even if the exposure period P1 has not ended, the counters 35A to 35D stop count processing.

FIG. 9 illustrates an operation example of the photodetector 20.

First, in the photodetector 20, the photodetection controller 25 starts the exposure period P1 (step S101). In the exposure period P1, the signal generator 22 generates the clock signals CLKA to CLKD on the basis of an instruction from the photodetection controller 25.

Next, the photodetection controller 25 confirms whether or not the exposure period P1 having a predetermined time length has ended (step S102). In a case where the exposure period P1 has ended (“Y” in step S102), processing proceeds to step S107.

In a case where the exposure period P1 has not yet ended (“N” in step S102), the saturation determining section 38 determines whether or not one or more count values CNT of four count values CNT (count values CNTA to CNTD) have reached the threshold THB (step S103). In a case where one or more count values CNT have reached the threshold THB (“Y” in step S103), the processing proceeds to step S106.

In step S103, in a case where none of the count values CNT has reached the threshold THB (“N” in step S103), the subtraction determining section 36 determines whether or not all of the four count values CNT (count values CNTA to CNTD) have reached the threshold THA (step S104). In a case where all of the count values CNT have not reached the threshold THA (“N” in step S104), the processing returns to step S102.

In step S104, in a case where all of the four count values CNT have reached the threshold THA (“Y” in step S104), the subtraction controller 37 subtracts a predetermined value from each of the count values CNTA to CNTD in the counters 35A to 35D (step S105). That is, in an example in FIG. 8, as illustrated in (B) and (C) of FIG. 8, all of the four count values CNT have reached the threshold THA, which causes the subtraction controller 37 to subtract the predetermined value from each of the count values CNTA to CNTD. The processing then returns to step S102.

In step S103, in a case where one or more count values CNT have reached the threshold THB (“Y” in step S103), the counters 35A to 35D stop count processing (step S106). That is, in the example in FIG. 8, as illustrated in (D) of FIG. 8, one or more count values CNT of the four count values CNT have reached the threshold THB, which causes the saturation determining section 38 to change the control signal STP from the low level to the high level. The AND circuits 33A to 33D each change the output signal to the low level on the basis of this control signal STP. Accordingly, the switches 34A to 34D stop supply of the pulse signal PLS to the counters 35A to 35D, and the counters 35A to 35D stop count processing.

The plurality of photodetection units U each perform such an operation individually.

Then, the photodetector 20 performs readout processing (step S107). Specifically, the readout controller 23 controls the operations of the plurality of photodetection units U to supply, to the signal processor 24, the count values CNTA to CND generated in each of the plurality of photodetection units U.

Thus, this processing ends.

The signal processor 24 generates a distance image on the basis of the count values CNTA to CNTD supplied from each of the plurality of photodetection units U.

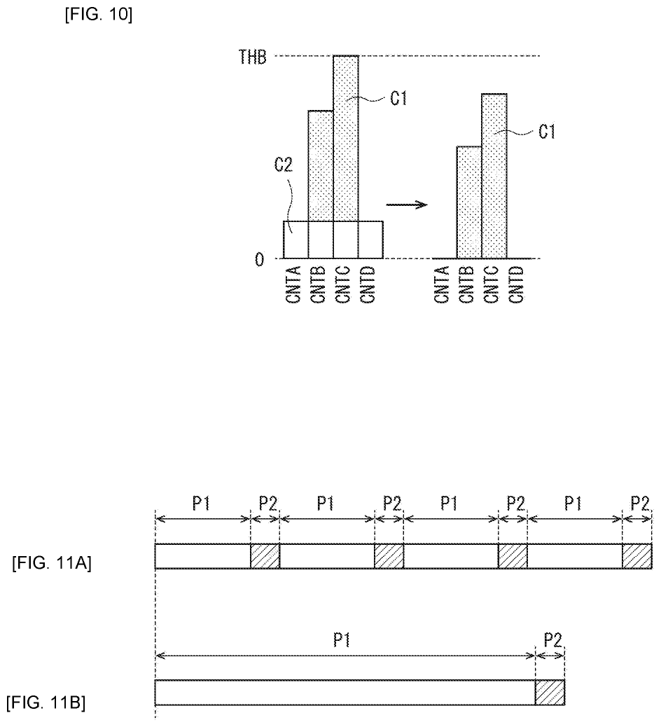

FIG. 10 illustrates an operation example of the signal processor 24. First, as illustrated in FIG. 10, the signal processor 24 subtracts the smallest value among the count values CNTA to CNTD from the count values CNTA to CNTD supplied from the photodetection unit U. That is, as illustrated in (D) of FIG. 8, the count values CNTA to CNTD generated by the photodetection unit U each include the reflected light component C1 and the ambient light component C2. As illustrated in FIG. 10, the signal processor 24 subtracts the smallest value among the count values CNTA to CNTD from the count values CNTA to CNTD to thereby remove the ambient light component C2.

Then, the signal processor 24 determines time (TOF value) from emission of the light pulse L0 by the light-emitting section 11 to detection of the reflected light pulse L1 by the photodetection unit U, on the basis of the count values CNTA to CNTD from which the ambient light component C2 is removed. That is, for example, the count value CNTA indicates the number of detection times of the reflected light pulse L1 directly after emission of the light pulse L0 by the light-emitting section 11, and the count value CNTD indicates the number of detection times of the reflected light pulse L1 after the lapse of time from the emission of the light pulse L0 by the light-emitting section 11. This makes it possible for the signal processor 24 to determine the TOF value on the basis of a distribution of these count values CNTA to CNTD, for example, by determining time corresponding to a peak of this distribution.

The signal processor 24 performs such processing on the basis of the count values CNTA to CNTD obtained from each of the plurality of photodetection units U to generate a distance image. Then, the signal processor 24 outputs image data of the generated distance image as the data DT.

Thus, in the photodetection system 1, the subtraction determining section 36 and the subtraction controller 37 perform subtraction processing for subtracting a predetermined value from each of the plurality of count values CNT, on the basis of one or more count values of a plurality of count values CNT. In particular, in this example, the subtraction determining section 36 and the subtraction controller 37 perform the subtraction processing in a case where all of the plurality of count values CNT have reached the threshold THA. In other words, the subtraction determining section 36 and the subtraction controller 37 perform the subtraction processing in a case where the smallest values among the plurality of count values CNT has reached the threshold THA. Accordingly, for example, as illustrated in (D) of FIG. 8, it is possible to decrease the final ambient light component C2 to the threshold THA or lower, which makes it possible to secure a signal amount of the reflected light component C1. As a result, in the photodetection system 1, it is possible to enhance detection accuracy of time (TOF value) or a distance.

That is, in a case where such subtraction processing is not performed, the amount of the ambient light component C1 is large under the condition that the amount of ambient light is large, which decreases the signal amount of the reflected light component C1. In a case where the signal amount is small in such a manner, detection accuracy of time or a distance is deteriorated. In addition, in this case, in order to prevent a decrease in the detection accuracy, it is possible to perform the operation illustrated in FIG. 7 a plurality of times. In this case, as illustrated in (A) of FIG. 11, a plurality of exposure periods P1 and a plurality of readout periods P2 are provided, which increases detection time.

In contrast, in the photodetection system 1, the subtraction determining section 36 and the subtraction controller 37 perform the subtraction processing for subtracting a predetermined value from each of the plurality of count values CNT, on the basis of one or more count values of the plurality of count values CNT. This makes it possible to secure the signal amount of the reflected light components C1, which makes it possible to enhance detection accuracy of time (TOF value) or a distance. In addition, as illustrated in (B) of FIG. 11, it is possible to reduce the number of readout periods P2 to one, which makes it possible to shorten a detection period.

In addition, in the photodetection system 1, the subtraction determining section 36 and the subtraction controller 37 perform the subtraction processing for subtracting a predetermined value from each of the plurality of count values CNT, which makes it possible to reduce the number of bits of a counter, thereby making it possible to reduce a circuit scale. That is, in a case where the subtraction processing is not performed, in order to secure the signal amount, a method of increasing the number of bits of the counter may be adopted. However, in this case, the circuit scale is increased. In a case where the circuit scale of the photodetection unit U is large, for example, the number of photodetection units U in the photodetection array may be decreased, or resolution may be decreased. In contrast, in the photodetection system 1, the subtraction processing for subtracting a predetermined value from each of the plurality of count values CNT is performed, which makes it possible to reduce the number of bits of the counter, thereby making it possible to reduce the circuit scale. Accordingly, for example, it is possible to increase the number of photodetection units U in the photodetection array 21 or to enhance resolution.

In addition, in the photodetection system 1, in each of the plurality of photodetection units U, the subtraction determining section 36 and the subtraction controller 37 performs the subtraction processing for subtracting a predetermined value from each of the plurality of count values CNT. This makes it possible to adaptively remove the ambient light component C2 in accordance with the light amount of ambient light in each of the plurality of photodetection units U, and makes it possible to secure the signal amount of the reflected light component C1. As a result, in the photodetection system 1, it is possible to effectively enhance detection accuracy of time (TOF value) or a distance in each of the plurality of photodetection units U.

### Effects

As described above, in the present embodiment, the subtraction processing for subtracting a predetermined value from each of the plurality of count values CNT is performed on the basis of one or more count values of the plurality of count values, which makes it possible to secure the signal amount, thereby making it possible to enhance detection accuracy.

### Modification Example 1-1

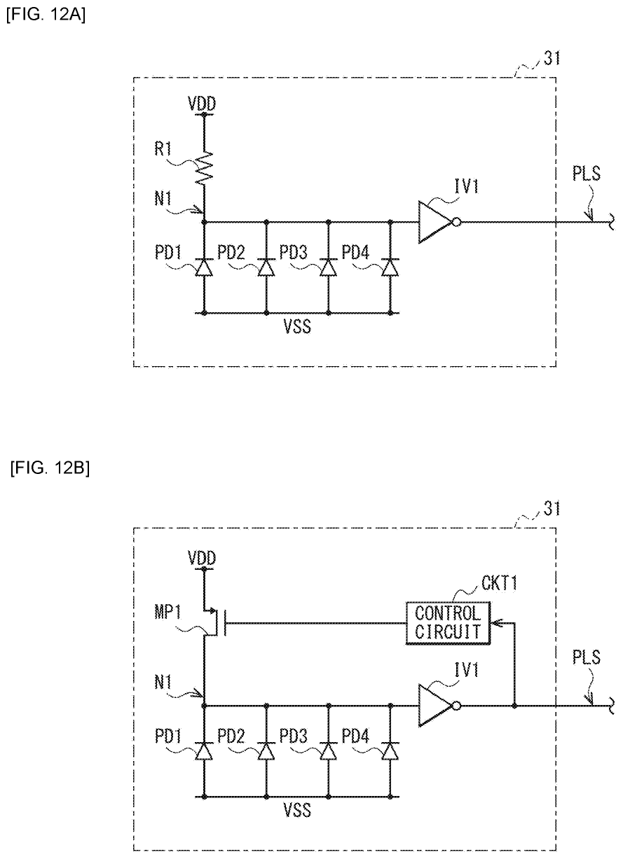

In the embodiment described above, as illustrated in FIGS. 4A and 4B, the light-receiving section 31 includes one photodiode PD, but this it not limitative. Instead of this, for example, as illustrated in FIGS. 12A and 12B, the light-receiving section 31 may include a plurality of photodiodes PD (four photodiodes PD1 to PD4 in this example). The photodiodes PD1 to PD4 are coupled in parallel to each other, and the photodiodes PD1 to PD4 each have an anode supplied with the power supply voltage VSS, and a cathode coupled to the node N1. This makes it possible to enhance, for example, light reception sensitivity in the light-receiving section 31.

### Modification Example 1-2

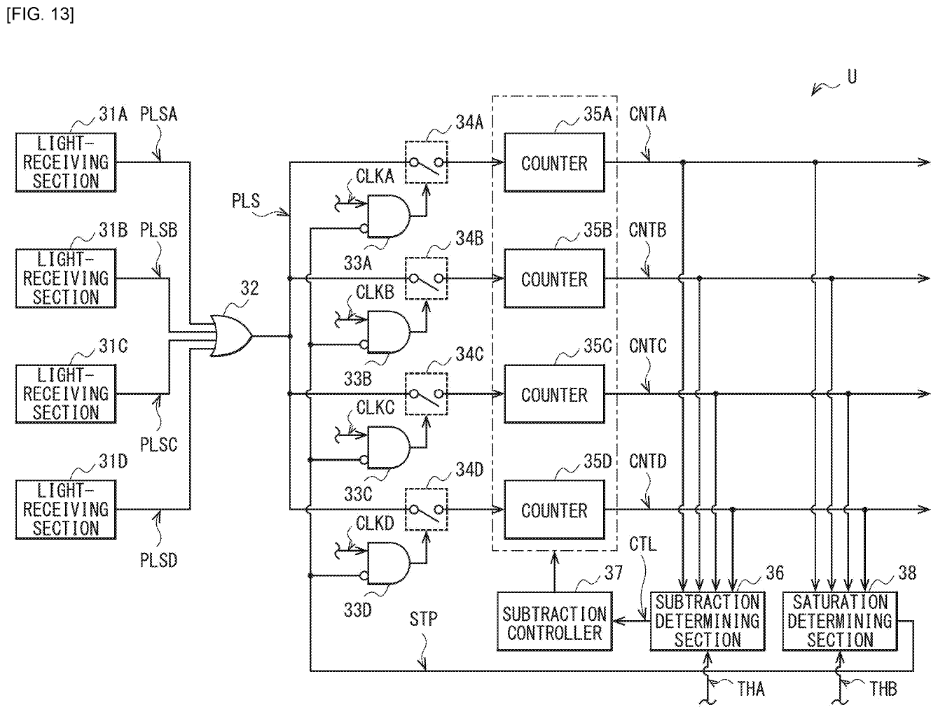

In the embodiment described above, as illustrated in FIG. 3, the photodetection unit U includes one light-receiving section 31, but this it not limitative. Instead of this, for example, as illustrated in FIG. 13, the photodetection unit U may include a plurality of light-receiving sections 31. This photodetection unit U includes a plurality of light-receiving section 31 (four light-receiving sections 31A to 31D in this example), and an OR circuit 32. The light-receiving sections 31A to 31D respectively generate the pulse signals PLSA to PLSD. Each of the plurality of light-receiving sections 31 has, for example, a circuit configuration illustrated in FIG. 4A or a circuit configuration illustrated in FIG. 4B. It is to be noted that, in this example, four light-receiving sections 31 are provided, but this is not limitative. For example, three or less or five or more light-receiving sections 31 may be provided. The OR circuit 32 is configured to generate the pulse signal PLS by finding logical OR of the pulse signals PLSA to PLSD. Here, the OR circuit 32 corresponds to a specific example of an “adder” in the present disclosure. Thus, it is possible to enhance, for example, light reception sensitivity in the photodetection unit U.

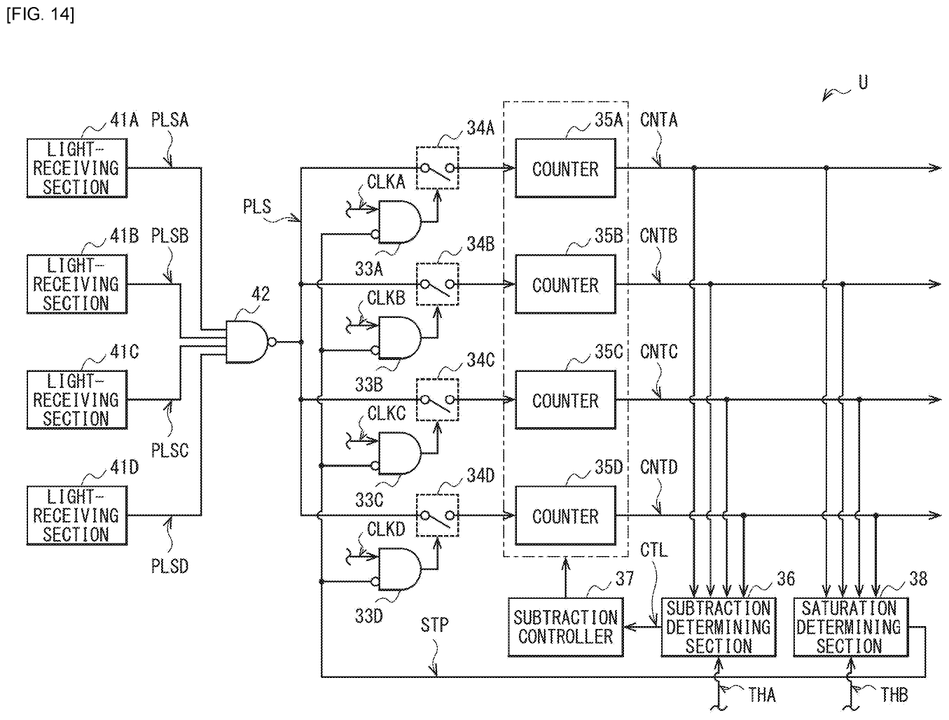

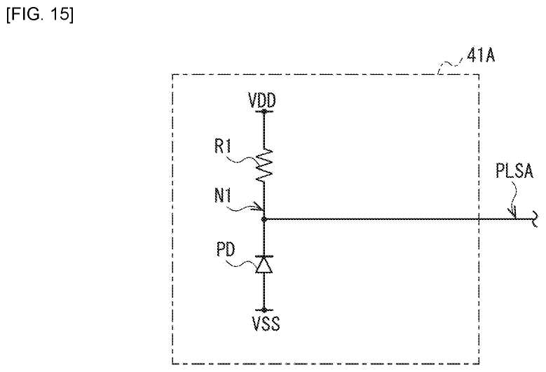

In addition, as illustrated in FIG. 14, the photodetection unit U may include a plurality of light-receiving sections 41 (four light-receiving sections 41A to 41D in this example) and a negative AND (NAND) circuit 42. The light-receiving sections 41A to 41D respectively generate the pulse signals PLSA to PLSD. As illustrated in FIG. 15, the light-receiving section 41A includes the photodiode PD and the resistor R1. That is, the light-receiving section 41A is the light-receiving section 31 (FIG. 4A) without the inverter IV1. The same applies to the light-receiving sections 41B to 41D. The NAND circuit 42 is configured to generate the pulse signal PLS by finding negative AND of the pulse signals PLSA to PLSD. Even in this case, it is possible to enhance, for example, light reception sensitivity.

### Modification Example 1-3

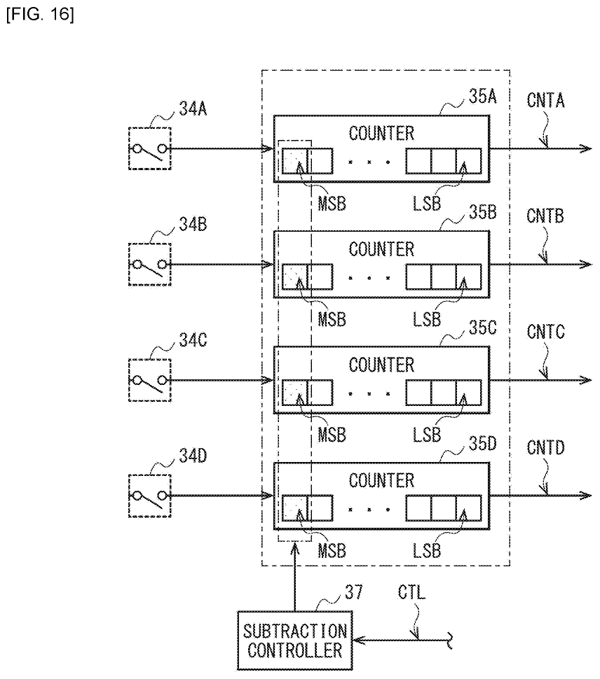

In the embodiment described above, the subtraction controller 37 performs subtraction processing for subtracting a predetermined value from each of the count values CNTA to CNTD in the counters 35A to 35D, on the basis of a determination result of the subtraction determining section 36. The subtraction controller 37 may perform subtraction processing by changing the bit value of a predetermined count bit in each of the counters 35A to 35D. Specifically, for example, as illustrated in FIG. 16, the subtraction controller 37 is able to perform subtraction processing by changing the bit value of a most significant bit (MSB: Most Significant Bit) in each of the counters 35A to 35D from “1” to “0”. This makes it possible to simplify the circuit configuration of the subtraction controller 37, and makes it possible to reduce a circuit scale. It is to be noted that, in this example, the bit value of the most significant bit is changed, but this is not limitative. The bit value of any other bit may be changed, or the bit values of a plurality of bits may be changed.

### Modification Example 1-4

In the embodiment described above, the subtraction determining section 36 determines whether or not all of the count values CNTA to CNTD has reached the threshold THA, but this is not limitative. The present modification example is described in detail below with reference to some examples.

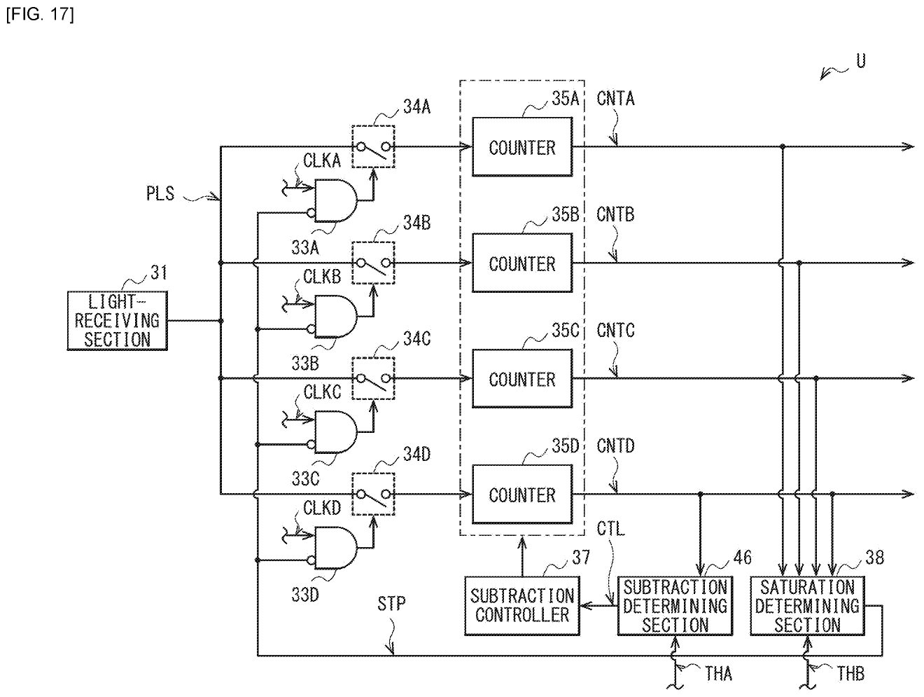

FIG. 17 illustrates a configuration example of the photodetection unit U according to the present modification example. This photodetection unit U includes a subtraction determining section 46. The subtraction determining section 46 is configured to generate the control signal CTL by determining whether or not the count value CNT of a predetermined counter 35 (the count value CNTD of the counter 35D in this example) of the four counters 35A to 35D has reached the threshold THA.

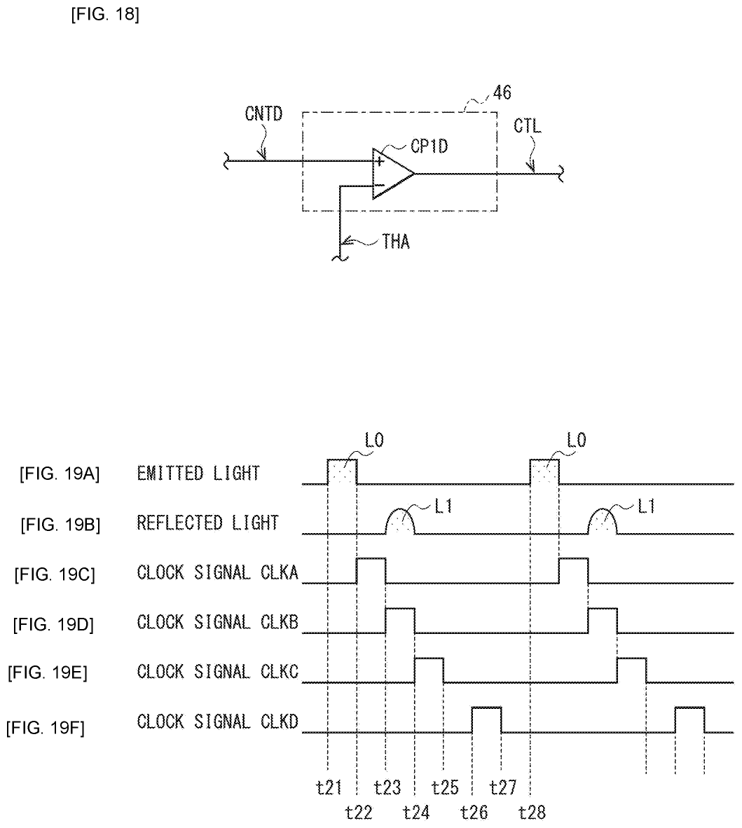

FIG. 18 illustrates a configuration example of the subtraction determining section 46. The subtraction determining section 46 includes the comparator circuit CP1D. The comparator circuit CP1D is configured to generate the control signal CTL by determining whether or not the count value CNTD is larger than the threshold THA.

FIG. 19 illustrates an operation example in the exposure period P1 of the photodetection unit U according to the present modification example. (A) indicates a waveform of light emitted from the light-emitting section 11. (B) indicates a waveform of light reflected by the detection object OBJ and having entered then photodetection unit U. (C) to (F) respectively indicate waveforms of the clock signals CLKA to CLKD.

In a period from a timing t21 to a timing t22, the light-emitting section 11 emits light ((A) of FIG. 19). The signal generator 22 changes the clock signal CLKA to the high level in a period from the timing t22 to a timing t23, changes the clock signal CLKB to the high level in a period from the timing t23 to a timing t24, and changes the clock signal CLKC to the high level in a period from the timing t24 to a timing t25 ((C) to (E) of FIG. 19). In this example, a timing of the reflected light pulse L1 is expected to some extent, and the signal generator 22 sequentially changes the clock signals CLKA to CLKC to the high level in a period from the timing t22 to the timing t25 including a period in which this reflected light pulse L1 is generated. In addition, the signal generator 22 changes the clock signal CLKD to the high level in a period from a timing t26 to a timing t27 separated from this period from the timing t22 to the timing t25 ((F) of FIG. 19). That is, in this example, the photodetection unit U does not detect the reflected light pulse L1 in this period from the timing t26 to the timing t27; therefore, it is expected to detect ambient light. Accordingly, the count value CNTD does not include the reflected light component C1, and includes the ambient light component C2.

In the photodetection unit U, the subtraction determining section 46 determines whether or not the count value CNTD of the counter 35D has reached the threshold THA, and in a case where the count value CNTD has reached the threshold THA, the subtraction controller 37 subtracts a predetermined value from each of the count values CNTA to CNTD in the counters 35A to 35D.

This makes it possible to simplify the circuit configuration and reduce the circuit scale in the photodetection unit U according to the present modification example. The present modification example is effective specifically in a case where the number of circuits including the AND circuit 33, the switch 34, and the counter 35 is large. For example, in a case where sixteen counters 35 are included, it is possible to determine whether or not to perform subtraction processing on the basis of the count value CNT of one counter 35 of the sixteen counters 35, and it is possible to generate a distance image on the basis of the count values CNT of fifteen counters 35.

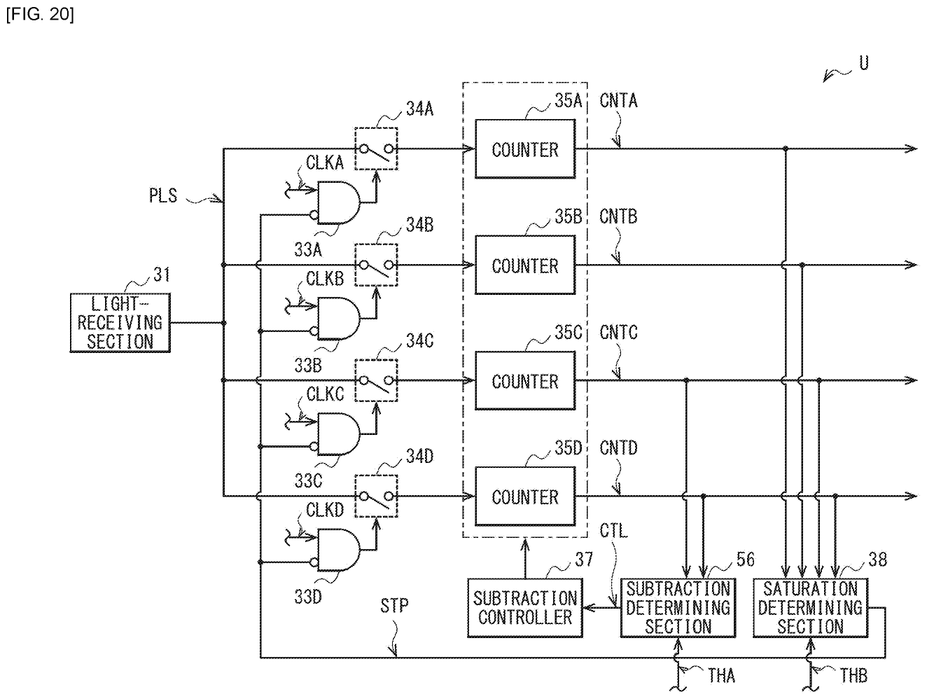

FIG. 20 illustrates a configuration example of another photodetection unit U according to the present modification example. This photodetection unit U includes a subtraction determining section 56. The subtraction determining section 56 is configured to generate the control signal CTL by determining whether or not both the count values of two predetermined counters 35 (the count values CNTC and CNTD of the counters 35C and 35D in this example) of the four counters 35A to 35D have reached the threshold THA.

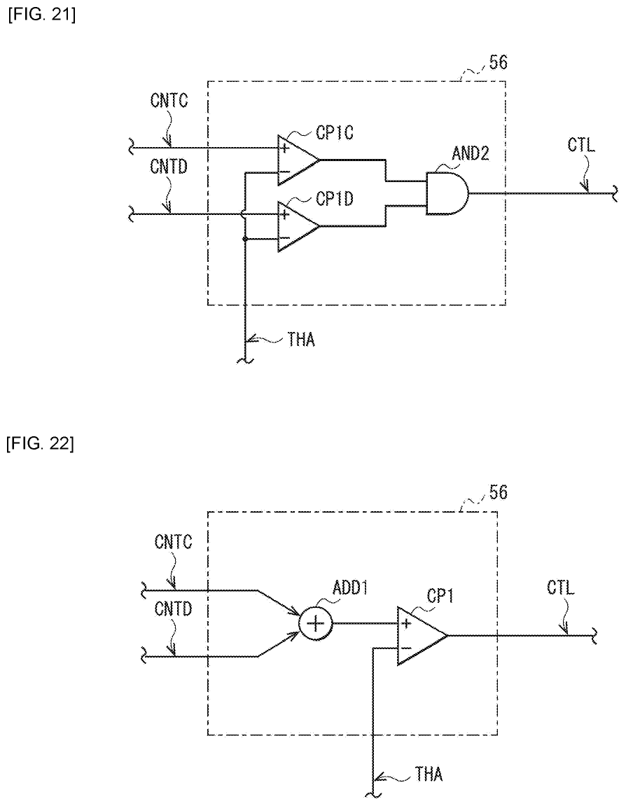

FIG. 21 illustrates a configuration example of the subtraction determining section 56. The subtraction determining section 56 includes the comparator circuits CP1C and CP1D and an AND circuit AND2. The comparator circuit CP1C is configured to determine whether or not the count value CNTC is larger than the threshold THA. The comparator circuit CP1D is configured to determine whether or not the count value CNTD is larger than the threshold THA. The AND circuit AND2 is configured to generate the control signal CTL by finding logical AND of output signals of the comparator circuits CP1C and CP1D. This configuration allows the subtraction determining section 56 to determine whether or not both the count values CNTC and CNTD have reached the threshold THA. As with the example in FIG. 19, the count values CNTC and CNTD each do not include the reflected light component C1, and include the ambient light component C2. The present modification example is effective in a case where the number of circuits including the AND circuit 33, the switch 34, and the counter 35 is large, as with the example in FIG. 19.

It is to be noted that this is not limitative, and the subtraction determining section 56 may generate the control signal CTL, for example, by determining whether or not the sum of the count values CNTC and CNTD reaches the threshold THA. FIG. 22 illustrates a configuration example of the subtraction determining section 56 in this example. This subtraction determining section 56 includes an adder circuit ADD1 and a comparator circuit CP1. The adder circuit ADD1 is configured to find the sum of the count value CNTC and the count value CNTD. The comparator circuit CP1 is configured to generate the control signal CTL by determining whether or not a value calculated by the adder circuit ADD1 is larger than the threshold THA. In this example, the subtraction determining section 56 determines whether or not the sum of the count values CNTC and CNTD reaches the threshold THA. However, instead of this, for example, the subtraction determining section 56 may determine whether or not an average value of the count values CNTC and CNTD reaches the threshold THA.

### Modification Example 1-5

In the embodiment described above, in a case where all of the count values CNTA to CNTD have reached the threshold THA, subtraction processing is performed asynchronously, but this is not limitative. Instead of this, for example, subtraction processing may be performed in synchronization with a control signal. The present modification example is described in detail below.

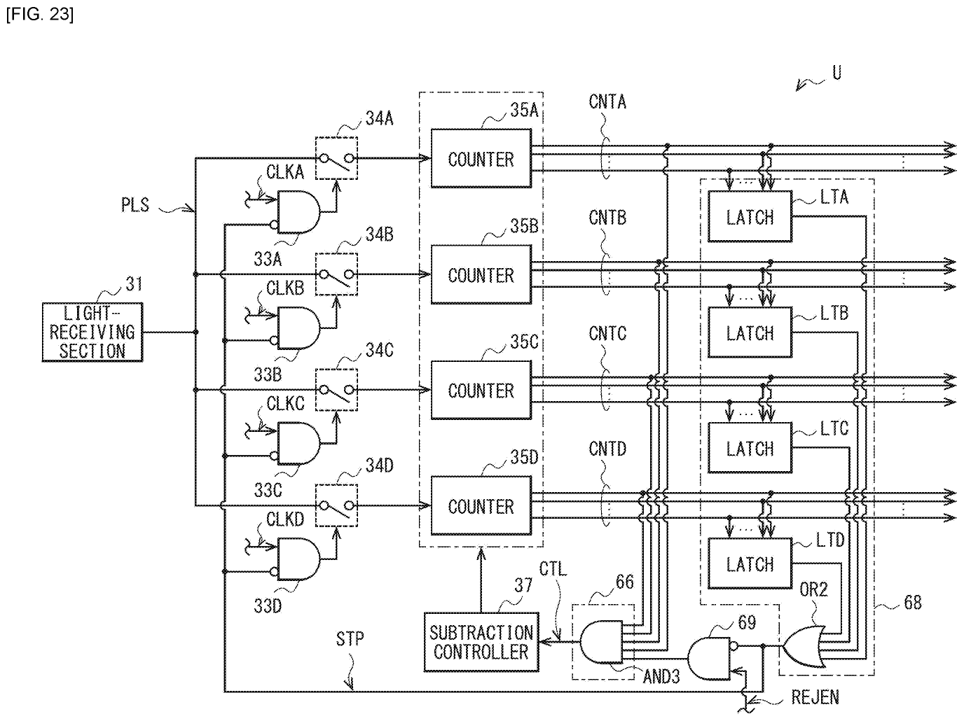

FIG. 23 illustrates a configuration example of the photodetection unit U according to the present modification example. This photodetection unit U includes a subtraction determining section 66, a saturation determining section 68, and an AND circuit 69.

The subtraction determining section 66 includes an AND circuit AND3. The AND circuit AND3 is configured to find logical AND of the bit value of a most significant bit of a signal indicating the count value CNTA, the bit value of a most significant bit of a signal indicating the count value CNTB, the bit value of a most significant bit of a signal indicating the count value CNTC, the bit value of a most significant bit of a signal indicating the count value CNTD, and the output signal of the AND circuit 69. Thus, the subtraction determining section 66 determines whether or not all of the count values CNTA to CNTD have reached an intermediate value in a count range of the counters 35A to 35D.

The saturation determining section 68 includes latches LTA to LTD and an OR circuit OR2. The latch LTA is configured to change an output signal to the high level in a case where all bits of the signal indicating the count value CNTA are changed to “1”. Likewise, the latch LTB is configured to change an output signal to the high level in a case where all bits of the signal indicating the count value CNTB are changed to “1”. The latch LTC is configured to change an output signal to the high level in a case where all bits of the signal indicating the count value CNTC are changed to “1”. The latch LTD is configured to change an output signal to the high level in a case where all bits of the signal indicating the count value CNTD are changed to “1” The OR circuit OR2 is configured to generate the control signal STP by finding logical OR of the output signal of the latch LTA, the output signal of the latch LTB, the output signal of the latch LTC, and the output signal of the latch LTD. Thus, the saturation determining section 68 generates the control signal STP by determining whether or not one or more counters 35 of the counters 35A to 35D are turned to an overflow state.

The AND circuit 69 is configured to find logical AND of an inverted signal of the control signal STP and a control signal REJEN. In this example, the control signal REJEN is generated by the signal generator 22, for example.

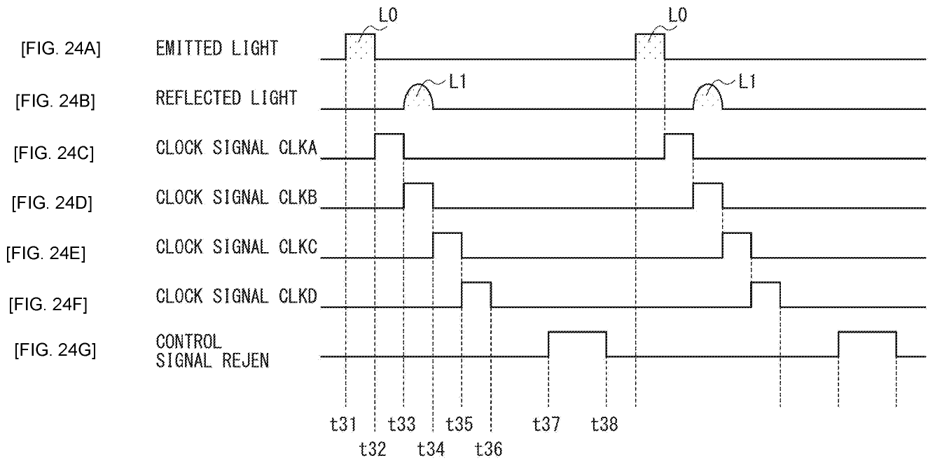

FIG. 24 illustrates an operation example in the exposure period P1 of the photodetection unit U according to the present modification example. (A) indicates a waveform of light emitted from the light-emitting section 11. (B) indicates a waveform of light reflected by the detection object OBJ and having entered the photodetection unit U. (C) to (F) respectively indicate waveforms of the clock signals CLKA to CLKD. (G) indicates a waveform of the control signal REJEN. In a period from a timing t31 to a timing t32, the light-emitting section 11 emits light ((A) of FIG. 24). The signal generator 22 changes the clock signal CLKA to the high level in a period from the timing t32 to a timing t33, changes the clock signal CLKB to the high level in a period from the timing t33 to a timing t34, changes the clock signal CLKC to the high level in a period from the timing t34 to a timing t35, and changes the clock signal CLKD to the high level in a period from the timing t35 to a timing t36 ((C) to (F) of FIG. 24). In addition, the signal generator 22 changes the control signal REJEN to the high level in a period from a timing t37 to a timing t38 different from this period from the timing t32 to the timing t36 ((G) of FIG. 24).

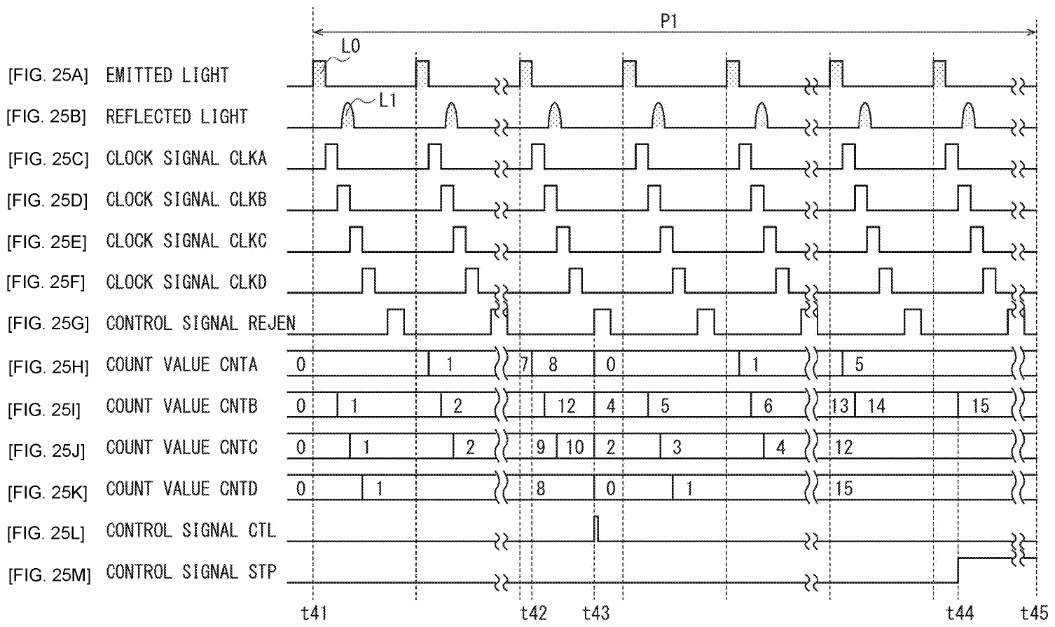

FIG. 25 illustrates a more specific operation example of the photodetection unit U according to the present modification example. (A) indicates a waveform of light emitted from the light-emitting section 11. (B) indicates a waveform of light reflected by the detection object OBJ and having entered the photodetection unit U. (C) to (F) respectively indicate waveforms of the clock signals CLKA to CLKD. (G) indicates a waveform of the control signal REJEN. (H) to (K) respectively indicate the count values CNTA to CNTD. (L) indicates a waveform of the control signal CTL. (M) indicates a waveform of the control signal STP. In this example, for explanatory convenience, the counter 35A to 35D are 4-bit counters, the threshold THA is “8”, and the threshold THB is “15”.

In a period from a timing t41 to a timing t45 (exposure period P1), the photodetection system 1 repeatedly emits the light pulse L0, and repeatedly detects the reflected light pulse L1 reflected by the detection object OBJ. The counter 35A performs count processing in a period in which the clock signal CLKA is at the high level to increment the count value CNTA ((C) and (H) of FIG. 25). Likewise, the counter 35B performs count processing in a period in which the clock signal CLKB is at the high level to increment the count value CNTB ((D) and (I) of FIG. 25). The counter 35C performs count processing in a period in which the clock signal CLKC is at the high level to increment the count value CNTC ((E) and (J) of FIG. 25). The counter 35D performs count processing in a period in which the clock signal CLKD is at the high level to increment the count value CNTD ((F) and (K) of FIG. 25).

At a timing t42, the count value CNTA changes from “7” to “8” ((H) of FIG. 25). The count value CNTA is the smallest value among the count values CNTA to CNTD; therefore, at this timing t42, the smallest value among the count values CNTA to CNTD reaches the threshold THA (“8” in this example). Then, at a timing t43 at which a control signal REJ is changed to the high level after this timing t42, the subtraction determining section 66 changes the control signal CTL from the low level to the high level ((L) of FIG. 25), and the subtraction controller 37 subtracts a predetermined value (“8” in this example) from each of the count values CNTA to CNTD in the counters 35A to 35D ((H) to (K) of FIG. 25). That is, the photodetection unit U subtracts the predetermined value from each of the count values CNTA to CNTD in the counters 35A to 35D at this timing in synchronization with the control signal REJEN. The count values CNTA to CNTD are decreased by this subtraction processing, which causes the subtraction determining section 66 to change the control signal CTL from the high level to the low level at a timing directly after this timing t43 ((L) of FIG. 25).

In addition, at a timing t44, the count value CNTB changes from “14” to “15” ((I) of FIG. 25). That is, the count value CNTB reaches the threshold THB (“15” in this example). This causes the saturation determining section 68 to change the control signal STP from the low level to the high level ((M) of FIG. 25). Accordingly, the switches 34A to 34D stop supply of the pulse signal PLS to the counters 35A to 35D, and the counters 35A to 35D stop count processing. It is to be noted that the control signal STP is at the high level from then on, which changes an output signal of the AND circuit 69 to the low level; therefore, the subtraction determining section 66 maintains the control signal CTL at the low level.

Thus, in the present modification example, the control signal REJEN is changed to the high level in a period different from a period in which the clock signals CLKA to CLKD are changed to the high level; therefore, the counters 35A to 35D do not perform count processing in a period in which the control signal REJEN is at the high level. This makes it possible for the subtraction controller 37 to subtract the predetermined value from each of the count values CNTA to CNTD in the counters 35A to 35D in a period in which the counters 35A to 35D do not perform count processing. As a result, count processing and subtracting processing are not simultaneously performed, which makes it possible to reduce a possibility that a malfunction occurs.

### Modification Example 1-6

The photodetector 20 according to the embodiment described above may be formed on one semiconductor substrate, or may be formed on a plurality of semiconductor substrates. The present modification example is described in detail below with reference to some examples.

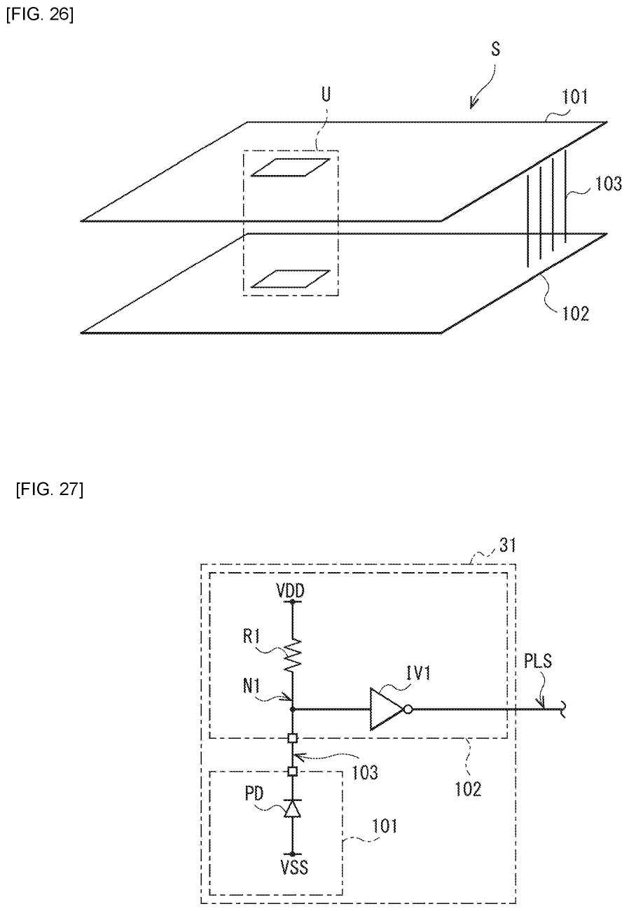

FIG. 26 illustrates an implementation example of the photodetector 20. In this example, the photodetector 20 is formed on two semiconductor substrates 101 and 102. The semiconductor substrate 101 is disposed on side of the light-receiving surface S of the photodetector 20, and the semiconductor substrate 102 is disposed on side opposite to the light-receiving surface S of the photodetector 20. The semiconductor substrates 101 and 102 are superimposed on each other. A wiring line of the semiconductor substrate 101 and a wiring line of the semiconductor substrate 102 are coupled to each other by a wiring line 103. It is possible to use, for example, a metallic bond such as Cu—Cu or a bump for the wiring line 103. The photodetection units U are disposed over these two semiconductor substrates 101 and 102.

FIG. 27 illustrates a configuration example of the light-receiving section 31. This light-receiving section 31 has the same circuit configuration as the light-receiving section 31 illustrated in FIG. 4A. In this example, the light-receiving section 31 is disposed over the two semiconductor substrates 101 and 102. Specifically, the photodiode PD is disposed on the semiconductor substrate 101, and the resistor R1 and the inverter IV1 are disposed on the semiconductor substrate 102. The photodiode PD has the cathode coupled to the other end of the resistor R1 and an input terminal of the inverter IV1 through the wiring line 103. Here, the inverter IV1 corresponds to a specific example of a “pulse generation circuit” in the present disclosure. It is to be noted that, in this example, the present modification example is applied to the photodetector 20 including the light-receiving section 31 illustrated in FIG. 4A, but the present modification example may be applied to the photodetector 20 including the light-receiving section 31 illustrated in FIG. 4B in a similar manner.

The AND circuits 33A to 33D, the switches 34A to 34D, the counters 35A to 35D, the subtraction determining section 36, the subtraction controller 37, and the saturation determining section 38 are disposed on the semiconductor substrate 102, for example.

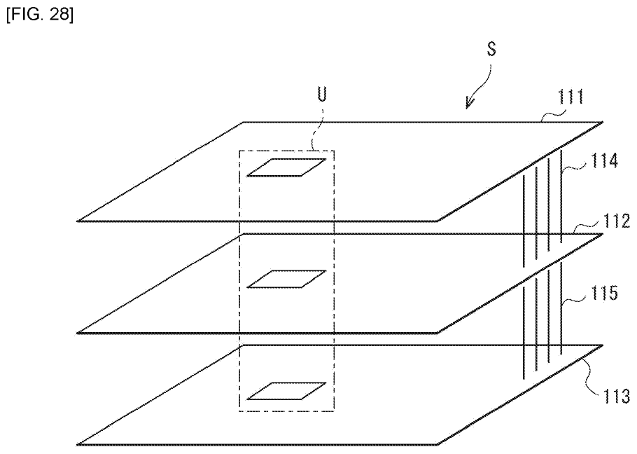

FIG. 28 illustrates another implementation example of the photodetector 20. In this example, the photodetector 20 is formed on three semiconductor substrates 111 to 113. The semiconductor substrate 111 is disposed on side of the light-receiving surface S of the photodetector 20, and the semiconductor substrate 113 is disposed on side opposite to the light-receiving surface S of the photodetector 20. The semiconductor substrate 112 is disposed between the semiconductor substrate 111 and the semiconductor substrate 113. The semiconductor substrates 111 to 113 are superimposed on each other. A wiring line of the semiconductor substrate 111 and a wiring line of the semiconductor substrate 112 are coupled to each other by a wiring line 114. A wiring line of the semiconductor substrate 112 and a wiring line of the semiconductor substrate 113 are coupled to each other by a wiring line 115. It is possible to use, for example, a metallic bond such as Cu—Cu or a bump for the wiring lines 114 and 115. The photodetection units U are disposed over these three semiconductor substrates 111 to 113. Specifically, for example, the photodiode PD is disposed on the semiconductor substrate 111, the resistor R1 and the inverter IV1 are disposed on the semiconductor substrate 112, and the subtraction determining section 36, the subtraction controller 37, and the saturation determining section 38 are disposed on the semiconductor substrate 113.

### Modification Example 1-7

In the embodiment described above, the photodetection system 1 performs only a distance measuring operation, but this is not limitative. Instead of this, for example, the photodetection system 1 may be able to perform both the distance measuring operation and an imaging operation. The present modification example is described in detail below.

FIG. 29 illustrates a configuration example of a photodetection system 1A according to the present modification example. The photodetection system 1A is configured to be operable as an image sensor and be operable as a ToF sensor. The photodetection system 1A includes a photodetector 80 and a controller 74.

The photodetector 80 is configured to detect light on the basis of an instruction from the controller 74. Then, the photodetector 20 outputs image data based on a detection result as the data DT.

The controller 74 is configured to supply control signals to the light-emitting section 11 and the photodetector 80 and control operations of the light-emitting section 11 and the photodetector 80 to thereby control an operation of the photodetection system 1A. The controller 74 includes a mode setting section 75. The mode setting section 75 is configured to set an operation mode M of the photodetection system 1A. The photodetection system 1A is operable in an imaging mode MA and a distance measurement mode MB. The imaging mode MA is a mode in which an image of a subject is captured on the basis of light L10 from the subject. The distance measurement mode MB is a mode in which the light pulse L0 is emitted and the reflected light pulse L1 reflected by the detection object OBJ is detected to thereby measure a time difference between a timing at which the light pulse L0 is emitted and a timing at which the reflected light pulse L1 is detected. The mode setting section 75 sets one of the imaging mode MA and the distance measurement mode MB as the operation mode M. Then, the controller 74 controls the operation of the photodetection system 1A in accordance with the set operation mode M.

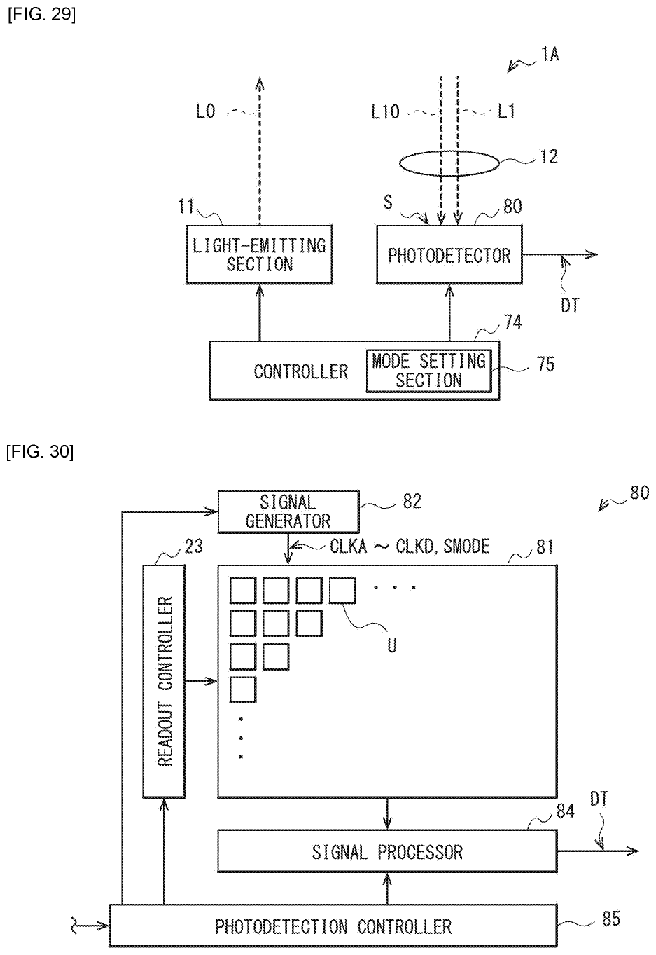

FIG. 30 illustrates a configuration example of the photodetector 80. The photodetector 80 includes a photodetection array 81, a signal generator 82, a signal processor 84, and a photodetection controller 85.

The photodetection array 81 includes a plurality of photodetection units U disposed in a matrix. The photodetection units U are each configured to detect light and count the number of detection times.

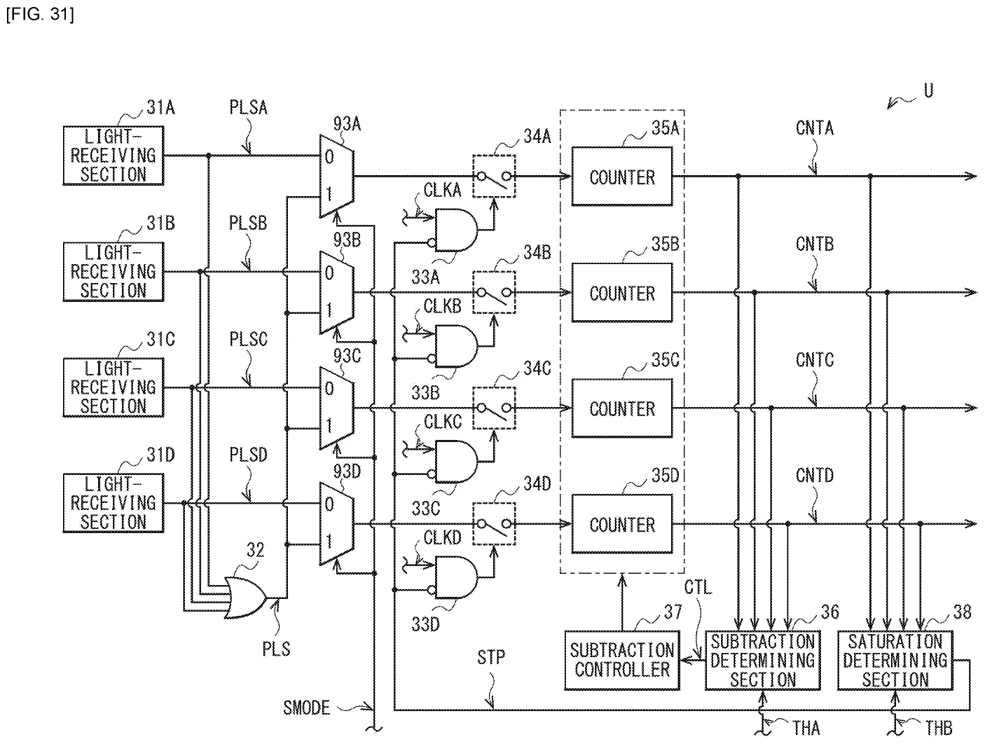

FIG. 31 illustrates a configuration example of the photodetection unit U. The photodetection unit U includes a plurality of light-receiving sections 31 (four light-receiving sections 31A to 31D in this example), an OR circuit 32, and a plurality of selectors 93 (four selectors 93A to 93D in this example).

The light-receiving sections 31A to 31D respectively generate the pulse signals PLSA to PLSD. Each of the light-receiving sections 31A to 31D has, for example, a circuit configuration illustrated in FIG. 4A or a circuit configuration illustrated in FIG. 4B. The OR circuit 32 is configured to generate the pulse signal PLS by finding logical OR of the pulse signals PLSA to PLSD.

The selector 93A is configured to select one of the pulse signal PLSA and the pulse signal PLS on the basis of a mode control signal SMODE and supply the selected pulse signal to the switch 34A. The mode control signal SMODE in this example is at a low level “0” in a case where the operation mode M is the imaging mode MA and is at a high level “1” in a case where the operation mode M is the distance measurement mode MB. Accordingly, the selector 93A selects the pulse signal PLSA in a case where the operation mode M is the imaging mode MA, and selects the pulse signal PLS in a case where the operation mode M is the distance measurement mode MB. Then, the selector 93A supplies the selected pulse signal to the switch 34A.

Likewise, the selector 93B is configured to select one of the pulse signal PLSB and the pulse signal PLS on the basis of the mode control signal SMODE and supply the selected pulse signal to the switch 34B. The selector 93C is configured to select one of the pulse signal PLSC and the pulse signal PLS on the basis of the mode control signal SMODE and supply the selected pulse signal to the switch 34C. The selector 93D is configured to select one of the pulse signal PLSD and the pulse signal PLS on the basis of the mode control signal SMODE and supply the selected pulse signal to the switch 34A.

In a case where the operation mode M is the imaging mode MA, the clock signals CLKA to CLKD rise at the same timing and falls at the same timing. Accordingly, the switches 34A to 34D respectively supplies the pulse signals PLSA to PLSD to the counters 35A to 35D in a period in which the clock signals CLKA to CLKD are at the high level. In addition, in a case where the operation mode M is the distance measurement mode MB, the clock signals CLKA to CLKD are four-phase clock signals, as illustrated in FIG. 7. The switches 34A to 34D distributes the pulse signal PLS to four counters 35A to 35D in a time division manner on the basis of the clock signals CLKA to CLKD.

The signal generator 82 (FIG. 30) is configured to generate the clock signals CLKA to CLKD and the mode control signal SMODE on the basis of an instruction from the photodetection controller 85 and supply the clock signals CLKA to CLKD and the mode control signal SMODE to the plurality of photodetection units in the photodetection array 81.

The signal processor 84 is configured to perform predetermined signal processing on the basis of an instruction from the photodetection controller 85. Specifically, in a case where the operation mode M is the imaging mode MA, the signal processor 84 generates image data of a captured image by performing predetermined image processing, on the basis of the count values CNTA to CNTD supplied from each of the plurality of photodetection units U in the photodetection array 81. In addition, in a case where the operation mode M is the distance measurement mode MB, the signal processor 84 generates image data of a distance image by measuring time from emission of the light pulse L0 by the light-emitting section 11 to detection of the reflected light pulse L1 by the photodetection unit U, on the basis of the count values CNTA to CNTD supplied from each of the plurality of photodetection units U in the photodetection array 81. The signal processor 84 then outputs the generated image data as the data DT.

The photodetection controller 85 is configured to control the operation of the photodetector 80 on the basis of an instruction from the controller 74 (FIG. 29) by supplying control signals to the signal generator 82, the readout controller 23, and the signal processor 84 and controlling operations of the signal generator 82, the readout controller 23, and the signal processor 84.

### Other Modification Examples

Two or more of these modification examples may be combined.

### 2. Second Embodiment

Next, description is given of a photodetection system 2 according to a second embodiment. The present embodiment has a configuration in which a counter is provided that counts the number of times subtraction processing for subtraction from the count values CNTA to CNTD of the counters 35A to 35D has been performed. It is to be noted that components substantially the same as those of the photodetection system 1 according to the first embodiment described above are denoted by the same reference numerals, and description thereof is omitted as appropriate.

The photodetection system 2 according to the present embodiment includes a photodetector 120, as with the photodetection system 1 (FIG. 1) according to the first embodiment described above.

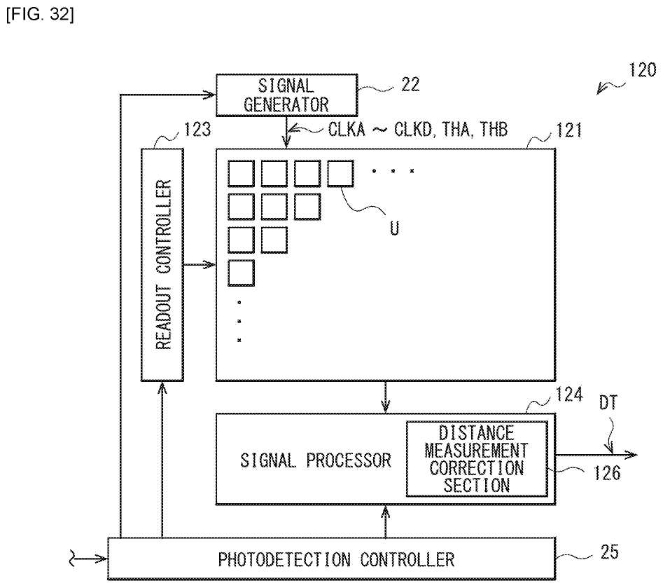

FIG. 32 illustrates a configuration example of the photodetector 120. The photodetector 120 includes a photodetection array 121, a readout controller 123, and a signal processor 124.

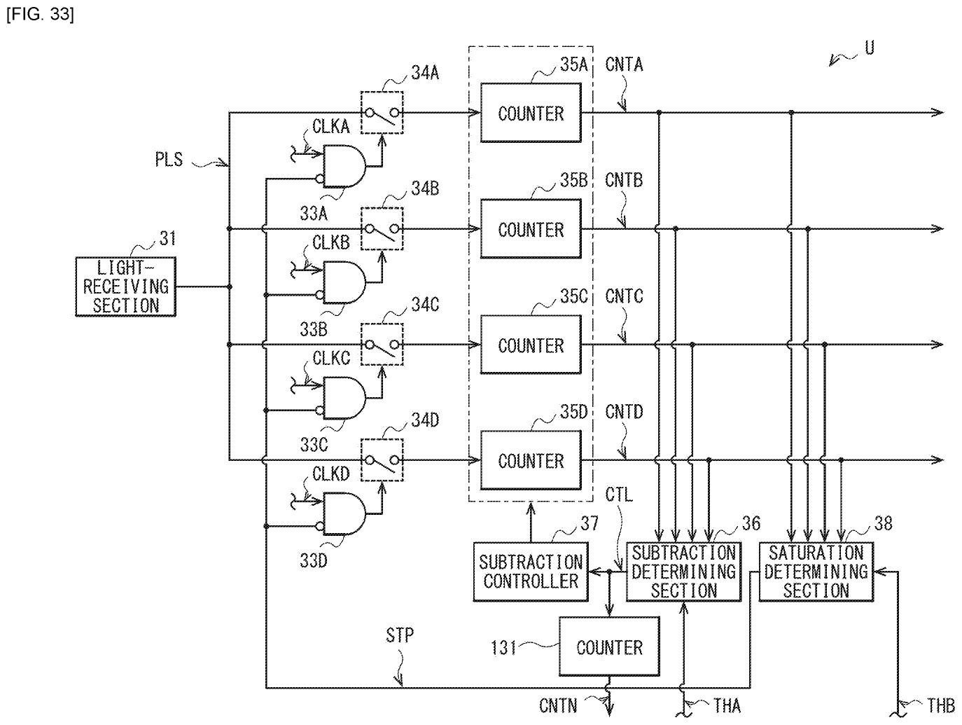

FIG. 33 illustrates a configuration example of the photodetection unit U in the photodetection array 121. The photodetection unit U includes a counter 131. The counter 131 is configured to count the number of times subtraction processing for subtracting a predetermined value from each of the count values CNTA to CNTD has been performed, on the basis of the control signal CTL generated by the subtraction determining section 36. The counter 131 then outputs the number of times the subtraction processing has been performed as a count value CNTN.

The readout controller 123 (FIG. 32) is configured to control an operation of supplying, to the signal processor 124, the count values CNTA to CNTD generated in each of the plurality of photodetection units U in the photodetection array 121, on the basis of an instruction from the photodetection controller 25.

The signal processor 124 is configured to generate a distance image on the basis of an instruction from the photodetection controller 25. Specifically, the signal processor 124 generates a distance image by measuring time (TOF value) from emission of the light pulse L0 by the light-emitting section 11 to detection of the reflected light pulse L1 by the photodetection unit U, on the basis of the count values CNTA to CNTD supplied from each of the plurality of photodetection units U in the photodetection array 21.

The signal processor 124 includes a distance measurement correction section 126. The distance measurement correction section 126 is configured to correct the TOF value on the basis of the count value CNTN. Specifically, the distance measurement correction section 126 calculates a full count value of the ambient light component C2 in the photodetection unit U on the basis of the count value CNTN, and corrects the TOF value with use of the full count value of the ambient light component C2.

FIG. 34 illustrates an example of the count values CNTA to CNTD. A portion W1 indicates the count values CNTA to CNTD supplied from the photodetection unit U. A portion W2 indicates a component removed by subtraction processing for the number of times indicated by the count value CNTN. It is possible to represent a count value in the portion W1 by the threshold THB. It is possible to represent a count value of the removed component indicated by the portion W2 by the product of the threshold THA and the count value CNTN. It is possible to represent the full count value of the ambient light component C2 by the sum of the smallest value among the count values CNTA to CNTD supplied from the photodetection unit U indicated in the portion W1 and the count value of the removed component (the product of the threshold THA and the count value CNTN) indicated in the portion W2.

The distance measurement correction section 126 corrects the TOF value on the basis of the full count value of the ambient light component C2. That is, in the photodetection unit U, the light-receiving section 31 is not able to detect subsequent light for a while after detecting light. The TOF value deviates to a value smaller than an actual value due to such dead time.

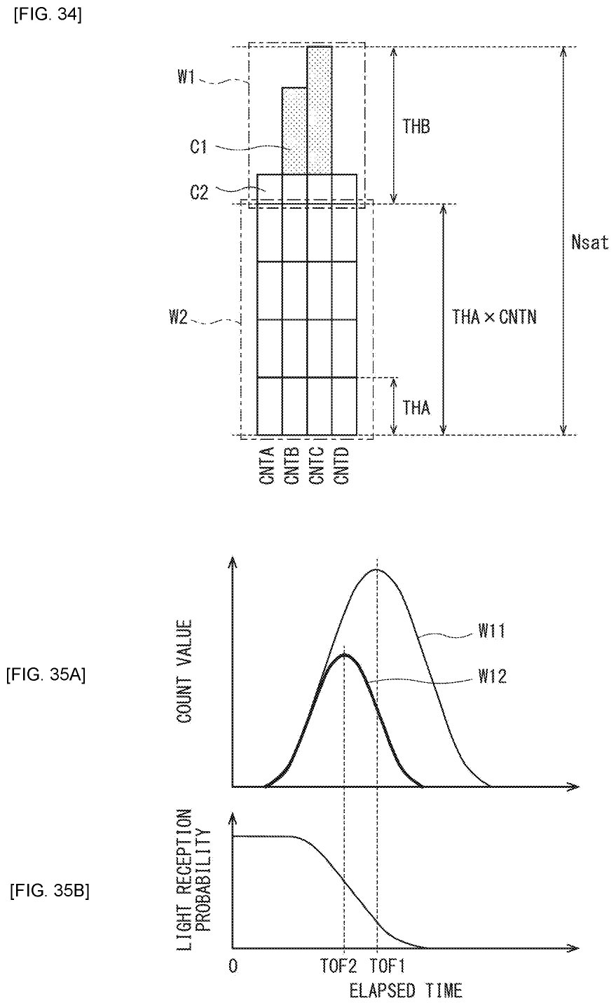

FIG. 35 illustrates an example of deviation of the TOF value caused by dead time in a case where there is no ambient light. (A) indicates a distribution of the count value CNT. (B) indicates a light reception probability in the light-receiving section 31. A horizontal axis indicates elapsed time with reference to a timing at which the light-emitting section 11 emits the light pulse L0. In (A) of FIG. 35, a characteristic W11 indicates a distribution of the count value CNT that is supposed to be obtained, and a characteristic W12 indicates a distribution of the count value CNT actually obtained.

The light-receiving section 31 is not able to detect subsequent light for a while after detecting light. Accordingly, the light reception probability of the light-receiving section 31 is as illustrated in (B) of FIG. 35. That is, in a case where the elapsed time is short, as indicated by the characteristic W11, a probability that reflected light enters the light-receiving section 31 is low; therefore, the light reception probability is high. As indicated by the characteristic W11, the probability that the reflected light enters the light-receiving section 31 becomes higher with the lapse of time. As described above, in a case where the light-receiving section 31 receives the reflected light, it is not possible to detect light in a period of the dead time described above. As a result, as the probability that the reflected light enters the light-receiving section 31 becomes higher with the lapse of time, the light reception probability is decreased. Thus, the light-receiving section 11 receives the reflected light with the light reception probability illustrated in (B) of FIG. 35.

As the light reception probability is decreased in such a manner with the lapse of time in a case where the distribution of the count value CNT that is supposed to be obtained is a distribution like the characteristic W11, the distribution of the actual count values CNT becomes like the characteristic W12, which causes deviation of time corresponding to a peak of the distribution of the count value CNT. That is, a TOF value (TOF2) obtained by the characteristic W12 becomes smaller than a TOF value (TOF1) obtained by the characteristic W11. The TOF value may deviate due to dead time of the light-receiving section 31 in such a manner.

Although the case where there is no ambient light has been described above, in a case where there is ambient light, the light-receiving section 11 receives both reflected light and ambient light with the light reception probability illustrated in (B) of FIG. 35. Accordingly, the light reception probability of the reflected light is decreased as compared with the case where there is no ambient light. The light reception probability of reflected light changes in such a manner; therefore, deviation of the TOF value may also change.

Accordingly, the distance measurement correction section 126 corrects the TOF value from TOF1 to TOF2 on the basis of the full count value of the ambient light component C2 in FIG. 35, for example. Specifically, the distance measurement correction section 126 is able to correct the TOF value on the basis of the full count value of the ambient light component C2 with use of, for example, a lookup table indicating a relationship between the full count value of the ambient light component C2 and a correction amount.

Here, the counter 131 corresponds to a specific example of a “second counter” in the present disclosure. The distance measurement correction section 124 corresponds to a specific example of a “second processor” in the present disclosure.

Thus, in the photodetection system 2, the TOF value is calculated on the is of the count values CNTA to CNTD of the counters 35A to 35D, and this TOF value is corrected on the basis of the count value CNTN of the counter 131, which makes it possible to enhance detection accuracy of time (TOF value) or a distance.

As described above, in the present embodiment, the TOF value is calculated on the basis of the count values CNTA to CNTD of the counters 35A to 35D, and this TOF value is corrected on the basis of the count value CNTN of the counter 131, which makes it possible to enhance detection accuracy.

### Modification Example 2-1

In the embodiment described above, the photodetection system 2 generates a distance image, but this is not limitative. Instead of this, for example, in addition to the distance image, an image (light reception amount image) indicating a light reception amount may be further generated. The present modification example is described in detail below.

A photodetection system 2A according to the present modification example includes a photodetector 140, as with the photodetection system 2 according to the embodiment described above.

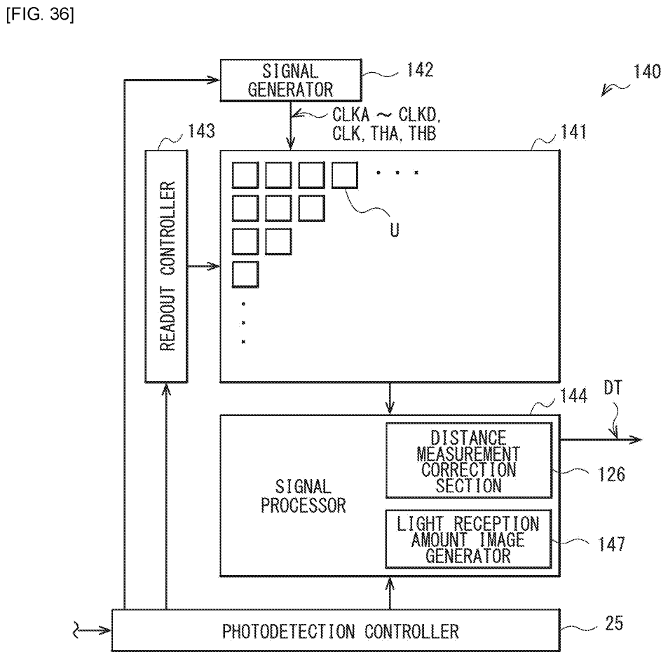

FIG. 36 illustrates a configuration example of the photodetector 140. The photodetector 140 includes a photodetection array 141, a signal generator 142, a readout controller 143, and a signal processor 144.

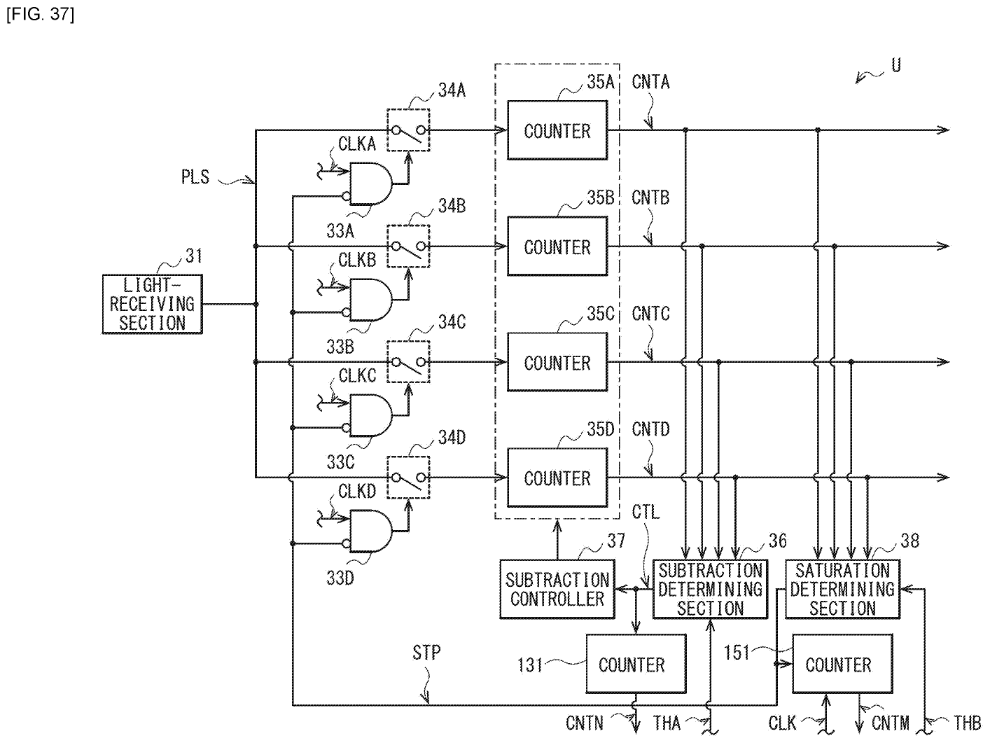

FIG. 37 illustrates a configuration example of the photodetection unit U in the photodetection array 141. The photodetection unit U includes a counter 151. The counter 151 is configured to count time from when the exposure period P1 starts to when one or more count values of the count values CNTA to CNTD reach the threshold THB by counting pulses of the clock signal CLK on the basis of the control signal STP generated by the saturation determining section 38. Specifically, the counter 151 performs count processing on the basis of the clock signal CLK generated in the exposure period P1 and stops the count processing on the basis of the control signal STP, which makes it possible to count time from when the exposure period P1 starts to when one or more count values of the count values CNTA to CNTD reach the threshold THB. Then, the counter 151 outputs a result of the count processing as a count value CNTM.

The signal generator 142 is configured to generate the clock signals CLKA to CLKD and CLK, and the thresholds THA and THB on the basis of an instruction from the photodetection controller 25 and supply the generated clock signals CLKA to CLKD and CLK, and the generated thresholds THA and THB to a plurality of photodetection units U in the photodetection array 141.

The readout controller 143 is configured to control an operation of supplying, to the signal processor 144, the count values CNTA to CNTD, CNTN, and CNTM generated in each of the plurality of photodetection units U in the photodetection array 141, on the basis of an instruction from the photodetection controller 25

The signal processor 144 includes a light reception amount image generator 147. The light reception amount image generator 147 is configured to generate a light reception amount image. Specifically, the light reception amount image generator 147 first calculates a count value Nsat with use of the following expression.

Nsat=THA×CNTN+THB

As illustrated in FIG. 34, Nsat is a full count value of the largest count value CNT (the count value CNTC in an example in FIG. 34) among the count values CNTA to CNTD in the photodetection unit U. This count value Nsat is a full count value obtained from when the exposure period P1 starts to when one or more count values of the count values CNTA to CNTD reach the threshold THB and the count processing stops.

Then, the light reception amount image generator 147 calculates a count value Nexp indicating a brightness value in the photodetection unit U with use of the following expression.

Nexp=Nsat×Texp/Tsat

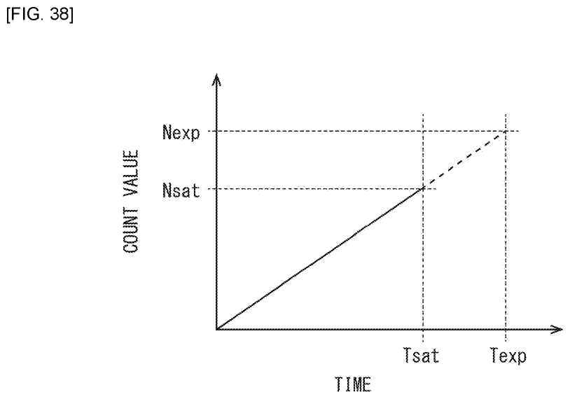

Here, Texp is a time length of the exposure period P1, and Tsat is a time length of a period (count period) from when the exposure period P1 starts to when one or more count values of the count values CNTA to CNTD reach the threshold THB and the count processing stops. The light reception amount image generator 147 converts the count value Nsat obtained in the time Tsat that is the time length of the count period into the count value Nexp to be obtained in the time Texp that is the time length of the exposure period P1 with use of this expression, as illustrated in FIG. 38. That is, in each of the plurality of photodetection units U, the count processing individually stops; therefore, a timing at which the count processing stops may differ among the photodetection units U. Accordingly, the time length (time Tsat) of the period in which the count value Nsat is obtained may differ among the photodetection units U. Thus, the light reception amount image generator 147 converts the count value Nsat obtained in the time Tsat into the count value Nexp to be obtained in the time Texp that is the time length of the exposure period P1. This makes it possible for the light reception amount image generator 147 to then generate a light reception amount image on the basis of this count value Nexp in the plurality of photodetection units U.

Here, the counter 151 corresponds to a specific example of a “third counter” in the present disclosure. The light reception amount image generator 147 corresponds to a specific example of a “third processor” in the present disclosure.

It is to be noted that, in this example, the count value Nsat that is the full count value of the largest count value CNT (the count value CNTC in the example in FIG. 34) among the count values CNTA to CNTD is converted into the count value Nexp to generate a light reception amount image, but this is not limitative. For example, a total value of full count values of the four count values CNTA to CNTD may be converted into the count value Nexp to generate a light reception amount image. In addition, a full count value of the smallest count value CNT (e.g., the count value CNTA in the example in FIG. 34) among the four count values CNTA to CNTD may be converted into the count value Nexp to generate a light reception amount image. The signal processor 144 has pieces of information about the count values CNTA to CNTD, CNTN, and CNTM supplied from all the photodetection units U, which makes it possible for the light reception amount image generator 147 to generate a light reception amount image by any of such various methods on the basis of these pieces of information.

In addition, in this example, the counter 151 counts time from when the exposure period P1 starts to when one or more count values of the count values CNTA to CNTD reach the threshold THB, but this is not limitative. Instead of this, for example, the counter 151 may count time from when one or more count values of the count values CNTA to CNTD reach the threshold THB to when the exposure period P1 ends. In this case, the light reception amount image generator 147 is able to convert a result (count value CNTM) of count processing by the counter 151 into time from when the exposure period P1 starts to when one or more count values of the count values CNTA to CNTD reach the threshold THB, and calculate the count value Nexp on the basis of a result of such conversion.

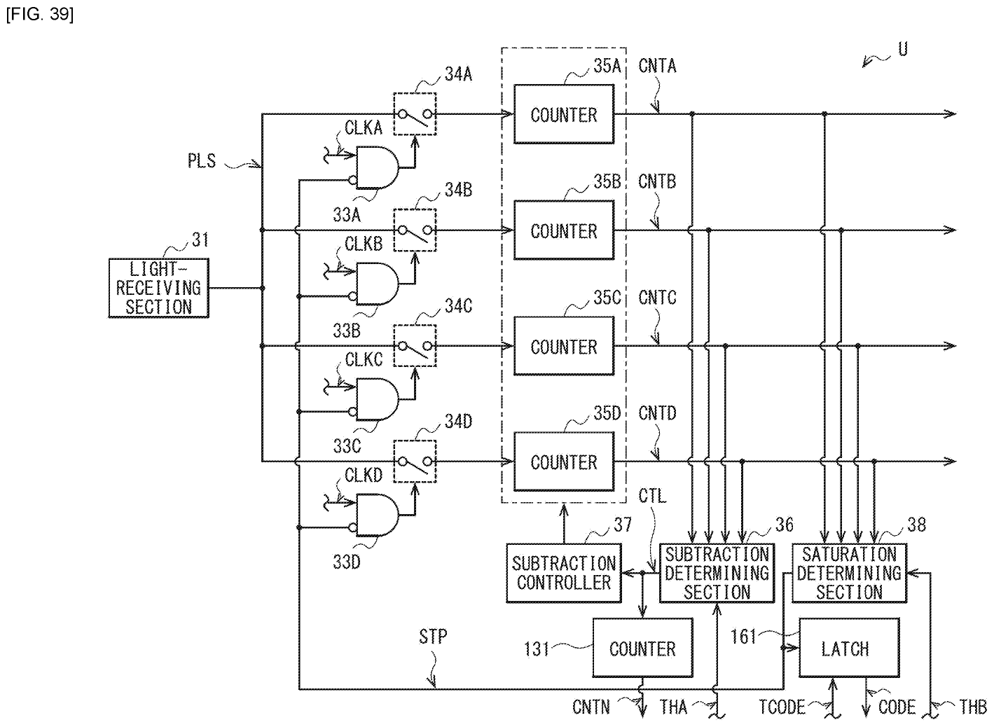

In addition, for example, as illustrated in FIG. 39, a latch 161 may be provided that latches, for example, a time code CODE on the basis of the control signal STP generated by the saturation determining section 38. The time code CODE is generated by, for example, the signal generator 142. Thus, the latch 161 generates a code CODE by latching a time code TCODE at a timing at which one or more count values of the count values CNTA to CNTD reach the threshold THB. In this case, the light reception amount image generator 147 is able to obtain time from when the exposure period P1 starts to when one or more count values of the count values CNTA to CNTD reach the threshold THB, on the basis of, for example, a timing at which the exposure period P1 starts and a timing indicated by this code CODE, and is ale to calculate the count value Nexp on the basis of this time. Here, the latch 161 corresponds to a specific example of a “latch circuit” in the present disclosure.

### Modification Example 2-2

In the embodiment described above, the present technology is applied to a TOF sensor, but this is not limitative. Instead of this, the present technology may be applied to, for example, an image sensor.

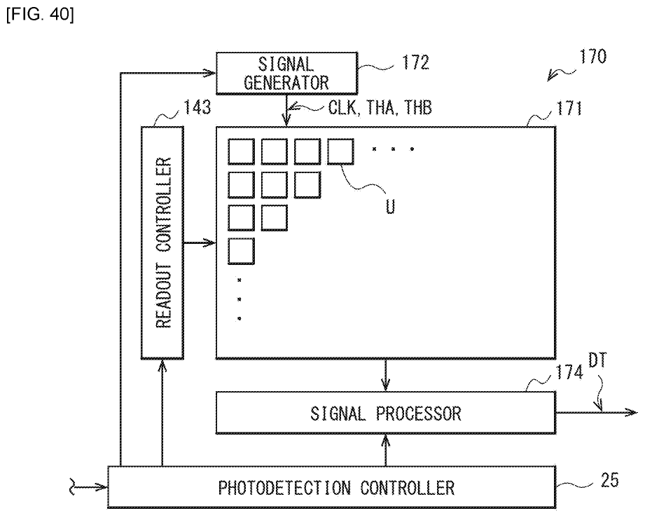

FIG. 40 illustrates a configuration example of a photodetector 170 according to the present modification example. The photodetector 170 includes a photodetection array 171, a signal generator 172, the readout controller 143, and a signal processor 174.

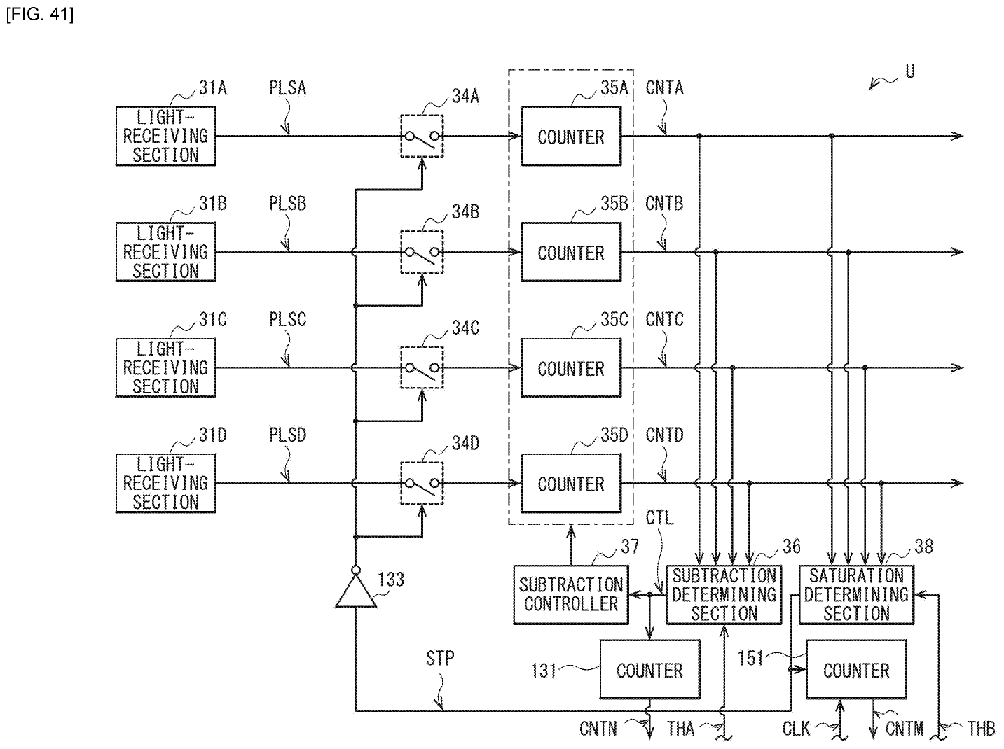

FIG. 41 illustrates a configuration example of the photodetection unit U in the photodetection array 171. The photodetection unit U includes the light-receiving sections 31A to 31D, an inverter 133, and the counter 151. The light-receiving sections 31A to 31D respectively generate the pulse signals PLSA to PLSD. The inverter 133 is configured to invert the control signal STP and supply a thus-inverted signal to the switches 34A to 34D. Accordingly, the switches 34A to 34D respectively supply the pulse signals PLSA to PLSD to the counters 35A to 35D in a case where the control signal STP is at the lo level, and stop supply of the pulse signals PLSA to PLSD to the counters 35A to 35D in a case where the control signal STP is at the high level. The counter 151 is configured to count time from when the exposure period P1 starts to when one or more count values of the count values CNTA to CNTD reach the threshold THB by counting pulses of the clock signal CLK on the basis of the control signal STP generated by the saturation determining section 38. Then, the counter 151 outputs a result of counting pulses of the clock signal CLK as the count value CNTM. It is to be noted that, in this example, four circuits including the light-receiving section 31, the switch 34, and the counter 35 are provided, but this is not limitative. For example, it is possible to provide two or more circuits including the light-receiving section 31, the switch 34, and the counter 35.

The signal generator 172 (FIG. 40) is configured to generate the clock signal CLK and the thresholds THA and THB on the basis of an instruction from the photodetection controller 25 and supply the generated clock signal CLK and the generated thresholds THA and THB to a plurality of photodetection units U in the photodetection array 171.

The readout controller 143 is configured to control an operation of supplying, to the signal processor 174, the count values CNTA to CNTD, CNTN, and CNTM generated in each of the plurality of photodetection units U in the photodetection array 171, on the basis of an instruction from the photodetection controller 25

The signal processor 174 is configured to generate a captured image on the basis of an instruction from the photodetection controller 25. Specifically, the signal processor 174 calculates a full count value of the count value CNTA obtained from when the exposure period P1 starts to when one or more count values of the count values CNTA to CNTD reach the threshold THB and count processing stops, on the basis of the count values CNTA and the count value CNTN supplied from the photodetection unit U. Then, the signal processor 174 converts the full count value of this count value CNTA into a count value to be obtained in the time Texp that is the time length of the exposure period P1, as with the light reception amount image generator 147. The same applies to the count values CNTB to CNTD. The signal processor 174 is able to generate a captured image in such a manner.

### Other Modification Examples

Each of the modification examples of the first embodiment described above may be applied to the photodetection system 2 according to the embodiment described above.

### 3. Third Embodiment

Next, description is given of a photodetection system 3 according to a third embodiment. The present embodiment is configured to have the thresholds THA and THB changeable. It is to be noted that components substantially the same as those of the photodetection system 1 according to the first embodiment described above are denoted by the same reference numerals, and description thereof is omitted as appropriate.

The photodetection system 3 according to the present embodiment includes a photodetector 220, as with the photodetection system 1 (FIG. 1) according to the first embodiment described above.

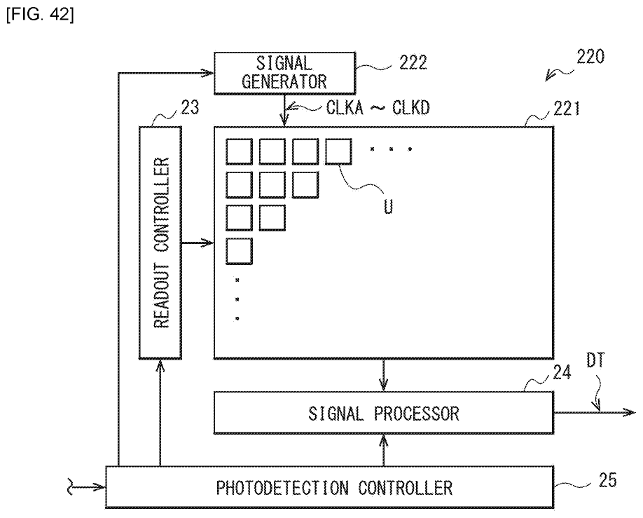

FIG. 42 illustrates a configuration example of the photodetector 220. The photodetector 220 includes a photodetection array 221 and a signal generator 222.

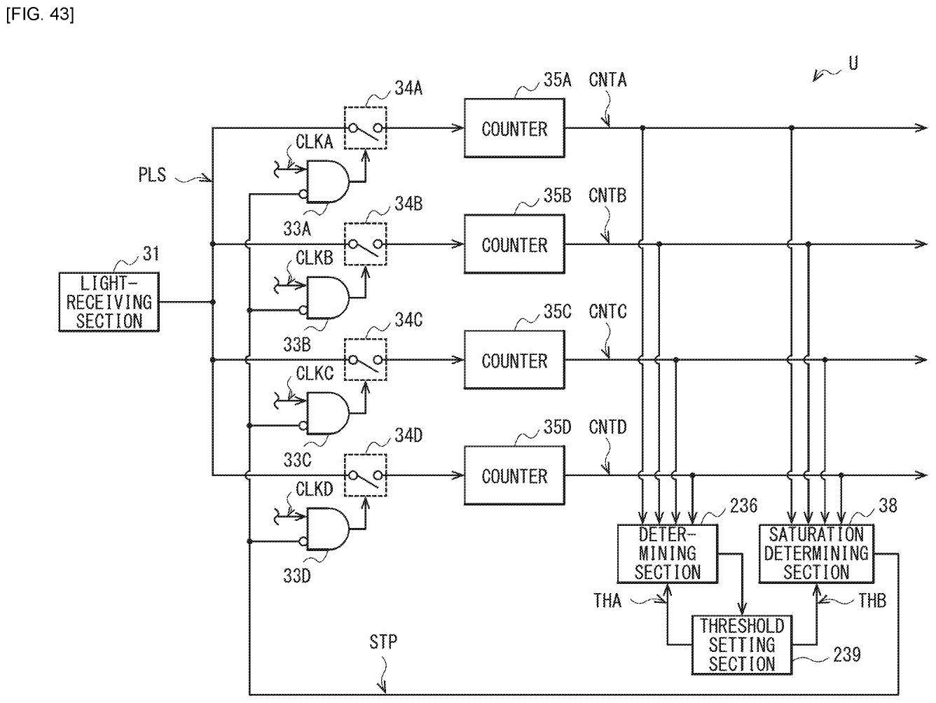

FIG. 43 illustrates a configuration example of the photodetection unit U in the photodetection array 221. The photodetection unit U includes a determining section 236 and a threshold setting section 239.

The determining section 236 is configured to determine whether or not all of the count values CNTA to CNTD have reached the threshold THA. In other words, the determining section 236 determines whether or not the smallest value among the count values CNTA to CNTD has reached the threshold THA. It is possible for the determining section 236 to have, for example, the same circuit configuration as the circuit configuration of the subtraction determining section 36 (FIG. 6).

The threshold setting section 239 is configured to set the thresholds THA and THB on the basis of a determination result of the determining section 236. Then, the threshold setting section 231 supplies the set threshold THA to the determining section 236, and supplies the set threshold THB to the saturation determining section 38.

The signal generator 222 (FIG. 42) is configured to generate the clock signals CLKA to CLKD on the basis of an instruction from the photodetection controller 25 and supply the generated clock signals CLKA to CLKD to the plurality of photodetection units U in the photodetection array 221.

Here, the determining section 236 and the threshold setting section 239 correspond to specific examples of a “threshold setting section” in the present disclosure. The saturation determining section 38 and the AND circuits 33A to 33D correspond to specific examples of a “stop processor” in the present disclosure.

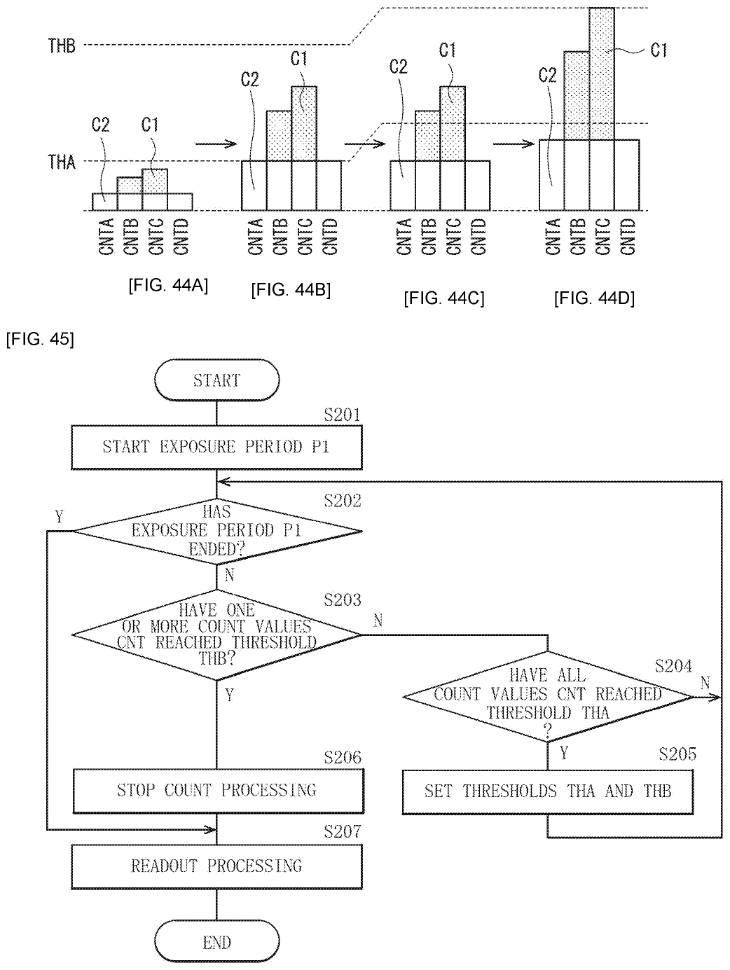

FIG. 44 illustrates an example of changes in the count values CNTA to CNTD in the exposure period P1.

When the exposure period P1 starts, the count values CNTA to CNTD gradually increase with the lapse of time. At a timing illustrated in (A) of FIG. 44, the ambient light component C2 in each of the count values CNTA to CNTD is smaller than the threshold value THA.

Thereafter, at a timing illustrated in (B) of FIG. 44, the ambient light component C2 in each of the count values CNTA to CNTD reaches the threshold THA. The determining section 236 determines that all of the count values CNTA to CNTD have reached the threshold THA. In other words, the determining section 236 determines that the smallest value among the count values CNTA to CNTD has reached the threshold THA. Accordingly, the threshold setting section 239 sets the threshold THA to a higher value, for example, by adding a predetermined value to the threshold THA, and sets the threshold THB to a higher value, for example, by adding a predetermined value to the threshold THB ((C) of FIG. 44).

Even after that, the count values CNTA to CNTD gradually increase with the lapse of time.

Then, at a timing illustrated in (D) of FIG. 44, the count value CNTC reaches the threshold THB. The saturation determining section 38 determines that one or more count values of the count values CNTA to CNTD have reached the threshold THB, and changes the control signal STP from the low level to the high level. The AND circuits 33A to 33D each change the output signal to the low level on the basis of this control signal STP. Accordingly, the switches 34A to 34D stop supply of the pulse signal PLS to the counters 35A to 35D, and the counters 35A to 35D stop count processing.

FIG. 45 illustrates an operation example of the photodetector 220.

First, in the photodetector 220, the photodetection controller 25 starts the exposure period P1 (step S201). In the exposure period P1, the signal generator 22 generates the clock signals CLKA to CLKD on the basis of an instruction from the photodetection controller 25.

Next, the photodetection controller 25 confirms whether or not the exposure period P1 having a predetermined time length has ended (step S202). In a case where the exposure period P1 has ended (“Y” in step S202), processing proceeds to step S207.

In a case where the exposure period P1 has not yet ended (“N” in step s202), the saturation determining section 38 determines whether or not one or more count values CNT of four count values CNT (count values CNTA to CNTD) have reached the threshold THB (step S203). In a case where one or more count values CNT have reached the threshold THB (“Y” in step S203), the processing proceeds to step S206.

In step S203, in a case where none of the count values CNT has reached the threshold THB (“N” in step S203), the determining section 236 determines whether or not all of the four count values CNT (count values CNTA to CNTD) have reached the threshold THA (step S204). In a case where all of the count values CNT have not reached the threshold THA (“N” in step S204), the processing returns to step S202.

In step S204, in a case where all of the four count values CNT have reached the threshold THA (“Y” in step S204), the threshold setting section 239 sets the threshold THA to a higher value, for example, by adding a predetermined value to the threshold THA, and sets the threshold THB to a higher value, for example, by adding a predetermined value to the threshold THB (step S205). That is, in an example in FIG. 44, as illustrated in (B) and (C) of FIG. 44, all of the four count values CNT have reached the threshold THA, which causes the threshold setting section 239 to set each of the thresholds THA and THB to a higher value. The processing then returns to step S202.

In step S203, in a case where one or more count values CNT have reached the threshold THB (“Y” in step S203), the counters 35A to 35D stop count processing (step S206). That is, in the example in FIG. 44, as illustrated in (D) of FIG. 44, one or more count values CNT of the four count values CNT have reached the threshold THB; which causes the saturation determining section 38 to change the control signal STP from the low level to the high level. The AND circuits 33A to 33D each change the output signal to the low level on the basis of this control signal STP. Accordingly, the switches 34A to 34D stop supply of the pulse signal PLS to the counters 35A to 35D, and the counters 35A to 35D stop count processing.

The plurality of photodetection units U each perform such an operation individually.

Then, the photodetector 220 performs readout processing (step S207). Specifically, the readout controller 23 controls the operations of the plurality of photodetection units U to supply, to the signal processor 24, the count values CNTA to CND generated in each of the plurality of photodetection units U.

Thus, this processing ends. Then, the signal processor 24 generates a distance image on the basis of the count values CNTA to CNTD supplied from each of the plurality of photodetection units U.

Thus, in the photodetection system 3, the determining section 236 and the threshold setting section 239 make a change to increase the threshold THB, on the basis of one or more count values of a plurality of count values CNT. In particular, in this example, in a case where all of the plurality of count values CNT have reached the threshold THA, the determining section 236 and the threshold setting section 239 make a change to increase the threshold THB. In other words, in a case where the smallest value among the plurality of count values CNT has reached the threshold THA, the determining section 236 and the threshold setting section 239 make a change to increase the threshold THB. Accordingly, as illustrated in (D) of FIG. 44, in a case where the amount of ambient light is large, it is possible to secure the signal amount of the reflected light component C1. As a result, in the photodetection system 1, it is possible to enhance detection accuracy of time (TOF value) or a distance. In addition, in a case where the amount of ambient light is small, for example, the threshold THB is not changed, which makes it possible to stop count processing in a shorter time. This makes it possible to reduce electric power consumption and shorten distance measurement time, for example.

In addition, in the photodetection system 3, in each of the plurality of photodetection units U, the determining section 236 and the threshold setting section 239 make a change to increase the threshold THB. This makes it possible to adaptively set the threshold THB in accordance with the light amount of ambient light in each of the plurality of photodetection units U. As a result, in the photodetection system 3, it is possible to effectively enhance detection accuracy of time (TOF value) or a distance in each of the plurality of photodetection units U.

As described above, in the present embodiment, the threshold THB is changed to be increased, on the basis of one or more count values of a plurality of count values, which makes it possible to secure the signal amount, thereby makes it possible to enhance detection accuracy.

### Modification Example 3

In the embodiment described above, the determining section 236 determines whether or not all of the count values CNTA to CNTD have reached the threshold THA, but this is not limitative. For example, as with the modification example 1-4 of the first embodiment described above, whether or not the count value CNT of a predetermined counter 35 of a plurality of counters 35 has reached the threshold THA may be determined, or whether or not both the count values of two predetermined counters 35 of the plurality of counters 35 have reached the threshold THA may be determined. In addition, whether or not the sum of the count values of these two counters 35 reaches the threshold THA may be determined, or whether or not an average value of the count values of these two counters 35 reaches the threshold THA may be determined.

### Other Modification Examples

Any of the modification examples of the first embodiment described above may be applied to the photodetection system 3 according to the embodiment described above.

### 4. Fourth Embodiment

Next, description is given of a photodetection system 4 according to a fourth embodiment. The present embodiment is a combination of technologies of the first embodiment and the third embodiment. It is to be noted that components substantially the same as those of the photodetection system 1 according to the first embodiment and the photodetection system 3 according to the third embodiment described above are denoted by the same reference numerals, and description thereof is omitted as appropriate.

The photodetection system 4 according to the present embodiment includes a photodetector 320, as with the photodetection system 3 according to the third embodiment described above. The photodetector 320 includes a photodetection array 321 and the signal generator 222, as with the photodetector 220 (FIG. 42) according to the third embodiment described above.

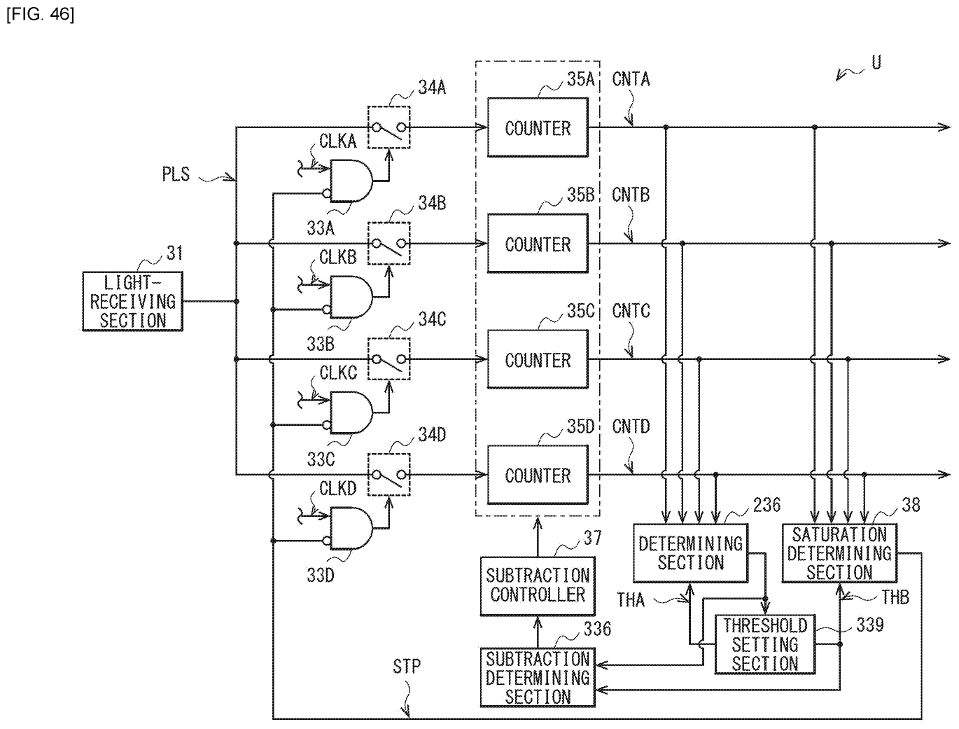

FIG. 46 illustrate a configuration example of the photodetection unit U in the photodetection array 321. The photodetection unit U includes a threshold setting section 339, a subtraction determining section 336, and the subtraction controller 37.

The threshold setting section 339 is configured to set the thresholds THA and THB on the basis of a determination result of the determining section 236 and the threshold THB. Specifically, the threshold setting section 339 sets the thresholds THA and THB in a case where the threshold THB has not reached a predetermined threshold THB0 under a condition that the determining section 236 determines that all of the count values CNTA to CNTD have reached the threshold THA, and supplies the set threshold THA to the determining section 236, and supplies the set threshold THB to the saturation determining section 38.

The subtraction determining section 336 is configured to determine whether or not to perform subtraction processing on the basis of a determination result of the determining section 236 and the threshold THB. Specifically, in a case where the threshold THB has reached the predetermined threshold THB0 under a condition that the determining section 236 determines that all of the count values CNTA to CNTD have reached the threshold THA, the subtraction determining section 336 determines to perform subtraction processing.

The subtraction controller 37 is configured to subtract a predetermined value from each of the count values CNTA to CNTD in the counters 35A to 35D on the basis of a determination result of this subtraction determining section 336.

The signal generator 222 is configured to generate the clock signals CLKA to CLKD on the basis of an instruction from the photodetection controller 25 and supply the generated clock signals CLKA to CLKD to the plurality of photodetection units U in the photodetection array 321.

Here, the determining section 236, the subtraction determining section 336, and the subtraction controller 37 correspond to specific examples of a “subtraction processor” in the present disclosure. The determining section 236 and the threshold setting section 339 correspond to specific examples of a “threshold setting section” in the present disclosure. The saturation determining section 38 and the AND circuits 33A to 33D correspond to specific examples of a “stop processor” in the present disclosure.

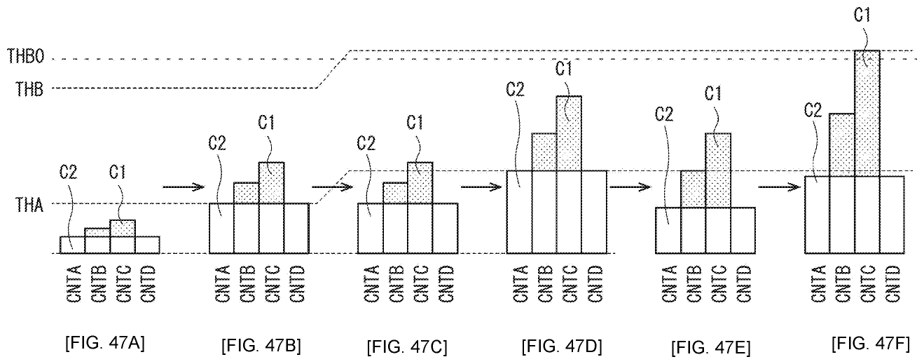

FIG. 47 illustrates an example of changes in the count values CNTA to CNTD in the exposure period P1.

When the exposure period P1 starts, the count values CNTA to CNTD gradually increase with the lapse of time. At a timing illustrated in (A) of FIG. 47, the ambient light component C2 in each of the count values CNTA to CNTD is smaller than the threshold THA.

Thereafter, at a timing illustrated in (B) of FIG. 47, the ambient light component C2 in each of the count values CNTA to CNTD reaches the threshold THA. The determining section 236 determines that all of the count values CNTA to CNTD have reached the threshold THA. In other words, the determining section 236 determines that the smallest value among the count values CNTA to CNTD has reached the threshold THA. At this time, the threshold THB has not yet reached the predetermined threshold THB0. Accordingly, the threshold setting section 239 sets the threshold THA to a higher value, for example, by adding a predetermined value to the threshold THA, and sets the threshold THB to higher value, for example, by adding a predetermined value to the threshold THB ((C) of FIG. 47).

Even after that, the count values CNTA to CNTD gradually increase with the lapse of time.

Then, at a timing illustrated in (D) of FIG. 47, the ambient light component C2 in each of the count values CNTA to CNTD reaches the changed threshold THA. The determining section 236 determines that all of the count values CNTA to CNTD have reached the threshold THA. In other words, the determining section 236 determines that the smallest value among the count values CNTA to CNTD has reached the threshold THA. At this time, the threshold THB reaches the predetermined threshold THB0. Accordingly, the subtraction determining section 336 determines to perform subtraction processing, and the subtraction controller 37 subtracts a predetermined value from each of the count values CNTA to CNTD ((E) of FIG. 47). Thus, a portion of the ambient light component C2 in each of the count values CNTA to CNTD is removed, and the reflected light component C1 is maintained.

Even after that, the count values CNTA to CNTD gradually increase with the lapse of time.

The, at a timing illustrated in (F) of FIG. 47, the count value CNTC reaches the threshold THB. The saturation determining section 38 determines that one or more count values of the count values CNTA to CNTD have reached the threshold THB, and changes the control signal STP from the low level to the high level. The AND circuits 33A to 33D each change the output signal to the low level on the basis of this control signal STP. Accordingly, the switches 34A to 34D stop supply of the pulse signal PLS to the counters 35A to 35D, and the counters 35A to 35D stop count processing.

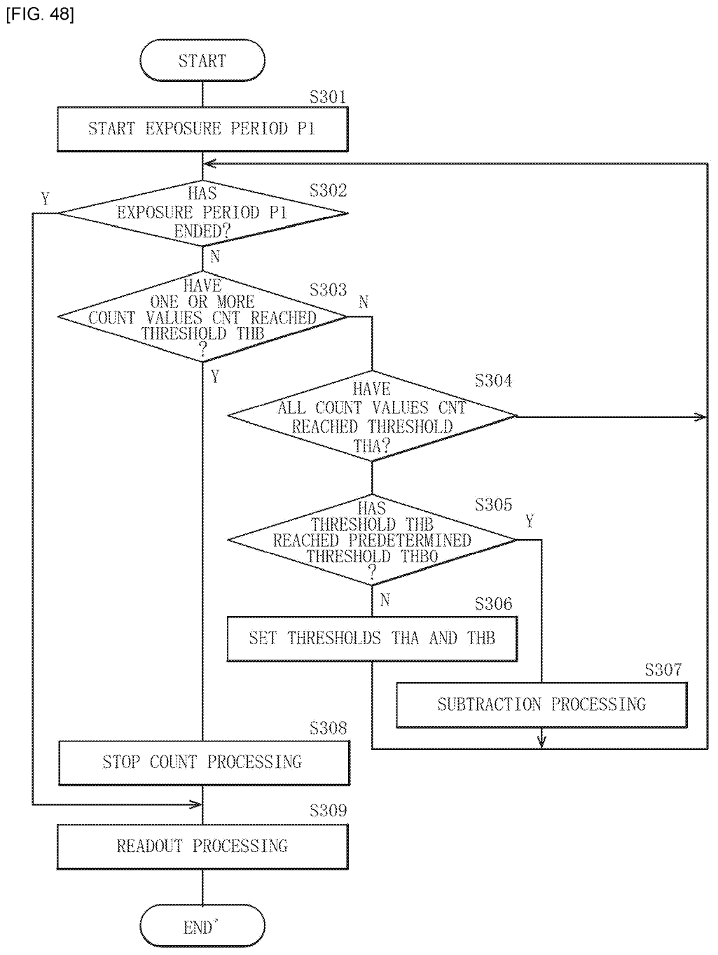

FIG. 48 illustrates an operation example of the photodetector 320.

First, in the photodetector 320, the photodetection controller 25 starts the exposure period P1 (step S301). In the exposure period P1, the signal generator 22 generates the clock signals CLKA to CLKD on the basis of an instruction from the photodetection controller 25.

Next, the photodetection controller 25 confirms whether or not the exposure period P1 having a predetermined time length has ended (step S302). In a case where the exposure period P1 has ended (“Y” in step S302), processing proceeds to step S309.

In a case where the exposure period P1 has not yet ended (“N” in step S302), the saturation determining section 38 determines whether or not one or more count values CNT of four count values CNT (count values CNTA to CNTD) have reached the threshold THB (step S303). In a case where one or more count values CNT have reached the threshold THB (“Y” in step S303), the processing proceeds to step S308.

In step S303, in a case where none of the count values CNT has reached the threshold THB (“N” in step S303), the determining section 236 determines whether or not all of the four count values CNT (count values CNTA to CNTD) have reached the threshold THA (step S304). In a case where all of the count values CNT have not reached the threshold THA (“N” in step S304), the processing returns to step S302.

In step S304, in a case where all of the four count values CNT have reached the threshold THA (“Y” in step S304), the threshold setting section 339 and the subtraction determining section 336 confirm whether or not the threshold THB has reached the predetermined threshold THB0 (step S305).

In step S305, in a case where the threshold THB has not reached the predetermined threshold THB0 (“N” in step S305), the threshold setting section 339 sets the threshold THA to a higher value, for example, by adding a predetermined value to the threshold THA, and sets the threshold THB to a higher value, for example, by adding a predetermined value to the threshold THB (step S306). That is, in an example in FIG. 47, as illustrated in (B) and (C) of FIG. 47, all of the four count values CNT have reached the threshold THA, and the threshold THB has not reached the predetermined threshold THB0, which causes the threshold setting section 239 to set each of the thresholds THA and THB to a higher value. The processing then returns to step S302.

In step S305, in a case where the threshold THB has reached the predetermined threshold THB0 (“Y” in step S305), the subtraction determining section 336 determines to perform subtraction processing, and the subtraction controller 37 subtracts a predetermined value from each of the count values CNTA to CNTD (step S307). That is, in the example in FIG. 47, as illustrated in (D) and (E) of FIG. 47, all of the four count values CNT have reached the threshold THA, and the threshold THB has reached the predetermined threshold THB0; therefore, the subtraction determining section 336 determines to perform subtraction processing, and the subtraction controller 37 subtracts a predetermined value from each of the count values CNTA to CNTD. The processing then returns to step S302.

In step S303, in a case where one or more count values CNT have reached the threshold THB (“Y” in step S303), the counters 35A to 35D stop count processing (step S308). That is, in the example in FIG. 47, as illustrated in (F) of FIG. 47, in a case where one or more count values CNT of the four count values CNT have reached the threshold THB, the saturation determining section 38 changes the control signal STP from the low level to the high level. The AND circuits 33A to 33D each change the output signal to the low level on the basis of this control signal STP. Accordingly, the switches 34A to 34D stop supply of the pulse signal PLS to the counters 35A to 35D, and the counters 35A to 35D stop count processing.

The plurality of photodetection units U each performs such an operation individually.

Then, the photodetector 320 performs readout processing (step S309). Specifically, the readout controller 23 controls the operations of the plurality of photodetection units U to supply, to the signal processor 24, the count values CNTA to CND generated in each of the plurality of photodetection units U.

Thus, this processing ends. Then, the signal processor 24 generates a distance image on the basis of the count values CNTA to CNTD supplied from each of the plurality of photodetection units U.

Thus, in the photodetection system 4, the determining section 236, the subtraction determining section 336, and the subtraction controller 37 perform subtraction processing for subtracting a predetermined value from each of a plurality of count values CNT on the basis of one or more count values of the plurality of count values CNT. Accordingly, for example, as with the first embodiment, in a case where the amount of ambient light is large, it is possible to decrease the final ambient light component C2 to the threshold THA or lower, which makes it possible to secure the signal amount of the reflected light component C1. As a result, in the photodetection system 4, it is possible to enhance detection accuracy of time (TOF value) or a distance.

In addition, in the photodetection system 4, the determining section 236 and the threshold setting section 339 make a change to increase the threshold THB, on the basis of one or more count values of the plurality of count values CNT. Accordingly, for example, as with the third embodiment, it is possible to secure the signal amount of the reflected light component C1 in a case where the amount of ambient light is large. As a result, in the photodetection system 4, it is possible to enhance detection accuracy of time (TOF value) or a distance. In addition, in a case where the amount of ambient light is small, for example, the threshold THB is not changed, which makes it possible to stop count processing in a shorter time. This makes it possible to reduce electric power consumption and shorten distance measurement time, for example.

As described above, in the present embodiment, on the basis of one or more count values of the plurality of count values CNT, the subtraction processing for subtracting a predetermined value from each of the plurality of count values CNT is performed, and the threshold THB is changed to be increased, which makes it possible to secure the signal amount, thereby makes it possible to enhance detection accuracy.

### Modification Example 4

In the embodiment described above, the determining section 236 determines whether or not all of the count values CNTA to CNTD have reached the threshold THA, but this is not limitative. For example, as with the modification example 1-4 of the first embodiment described above, whether or not the count value CNT of a predetermined counter 35 of a plurality of counters 35 has reached the threshold THA may be determined, or whether or not both the count values CNT of two predetermined counters 35 of the plurality of counters 35 have reached the threshold THA may be determined. In addition, whether or not the sum of the count values of these two counters 35 reaches the threshold THA may be determined, or whether or not an average value of the count values of these two counters reaches the threshold THA may be determined.

### Other Modification Examples

Each of the modification examples of the first embodiment described above may be applied to the photodetection system 4 according to the embodiment described above.

### 5. Example of Application to Mobile Body

The technology (the present technology) according to the present disclosure is applicable to a variety of products. For example, the technology according to the present disclosure may be achieved as a device mounted on any type of mobile body such as an automobile, an electric vehicle, a hybrid electric vehicle, a motorcycle, a bicycle, a personal mobility, an airplane, a drone, a vessel, or a robot.

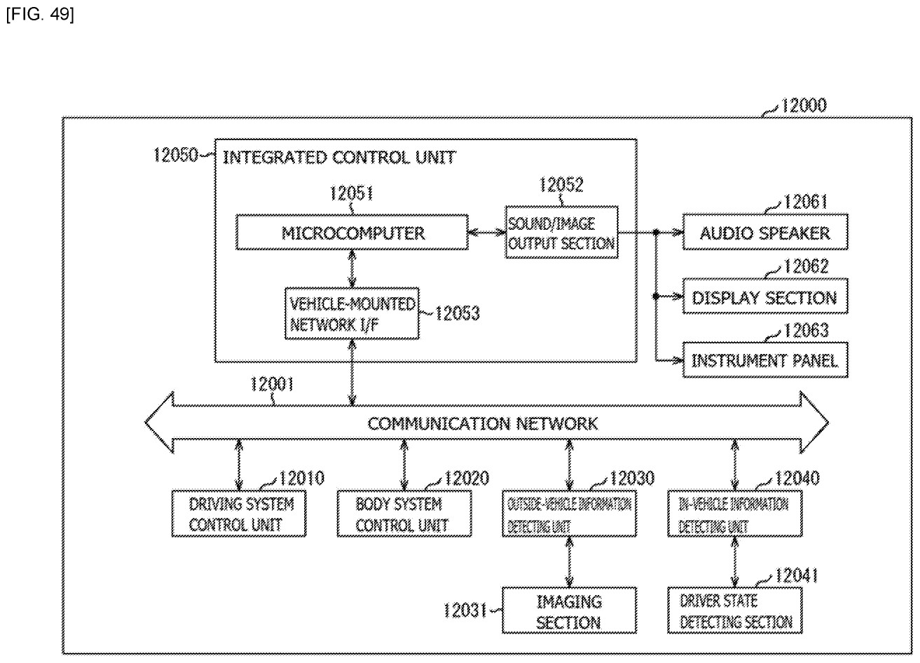

FIG. 49 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 49, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 49, an audio speaker 12061, a display section 12062, and an instrument panel 12063 are illustrated as the output device. The display section 12062 may, for example, include at least one of an on-board display and a head-up display.

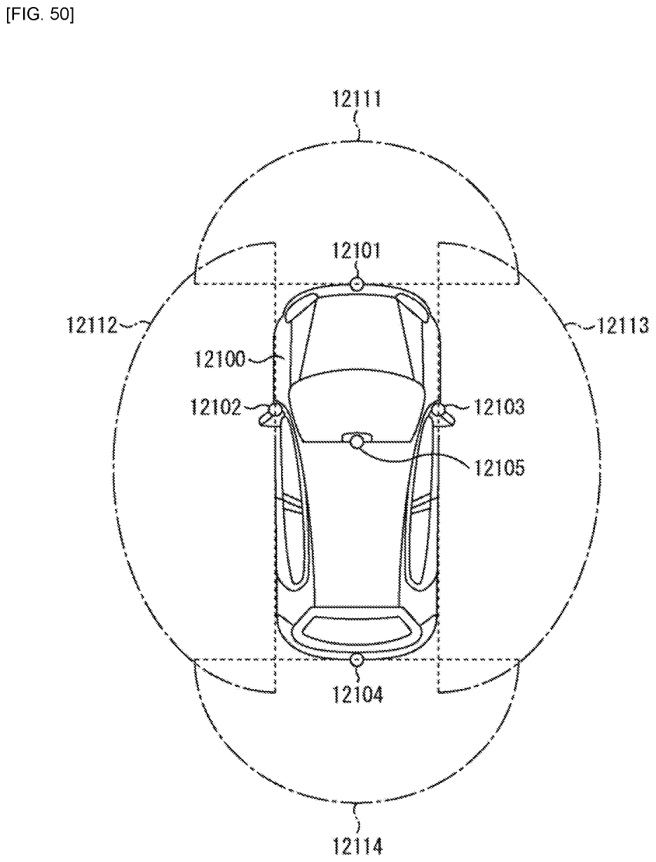

FIG. 50 is a diagram depicting an example of the installation position of the imaging section 12031.

In FIG. 50, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 50 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to the present disclosure may be applied has been described above. The technology according to the present disclosure may be applied to the imaging section 12031 among the components described above. This makes it possible to enhance detection accuracy of time (TOF value) or a distance in the vehicle control system 12000. As a result, this allows the vehicle control system 12000 to implement, with high accuracy, collision avoidance or shock mitigation for vehicles, a following driving function based on vehicle-to-vehicle distance, a vehicle speed maintaining driving function, a warning function of collision of the vehicle, a warning function of deviation of the vehicle from a lane, and the like.

Although the present technology has been described above with reference to some embodiments, the modification examples, and specific application examples thereof, the present technology is not limited to these embodiments and the like, and may be modified in a variety of ways.

For example, in the respective embodiments described above, the light-receiving section 31 as illustrated in FIGS. 4A and 4B is provided; however, the circuit configuration of the light-receiving section 31 is not limited thereto, and any of various circuit configurations is applicable to the light-receiving section 31.

It is to be noted that the effects described herein are merely illustrative and non-limiting, and other effects may be included.

It is to be noted that the present technology may have the following configurations. According to the present technology having the following configurations, it is possible to enhance detection accuracy.

(1)

A photodetection device including:
one or a plurality of light-receiving sections that each includes a light-receiving element, and generates a pulse signal including a pulse corresponding to a result of light reception by the light-receiving element;
a plurality of first counters that each performs count processing on the basis of one or a plurality of the pulse signals generated by the one or plurality of light-receiving sections, thereby generating a plurality of count values; and
a subtraction processor that performs subtraction processing for subtracting a predetermined value from each of the plurality of count values, on the basis of one or more count values of the plurality of count values.
   (2)

The photodetection device according to (1), further including a stop processor that stops the count processing in the plurality of first counters in a case where one or more count values of the plurality of count values have reached a first threshold.

(3)

The photodetection device according to (2), in which the subtraction processor performs the subtracting processing in a case where all of the plurality of count values have reached a second threshold.

(4)

The photodetection device according to (2), in which the subtraction processor performs the subtraction processing in a case where a smallest value among the plurality of count values has reached a second threshold.

(5)

The photodetection device according to (2), in which the subtraction processor performs the subtraction processing on the basis of the count values of one or more predetermined first counters of the plurality of first counters.

(6)

The photodetection device according to any one of (2) to (5), in which the subtraction processor performs the subtraction processing by changing a bit value of a predetermined count bit of a plurality of count bits in each of the plurality of first counters.

(7)

The photodetection device according to (6), in which the predetermined count bit includes a most significant bit of the plurality of count bits.

(8)

The photodetection device according to any one of (2) to (7), in which the subtraction processor performs the subtraction processing in a period in which each of the plurality of first counters does not perform the count processing.

(9)

The photodetection device according to any one of (2) to (8), in which the first threshold includes a largest possible count value taken by the plurality of count values.

(10)

The photodetection device according to any one of (2) to (9), further including a threshold setting section that makes a change to increase the first threshold, on the basis of one or more count values of the plurality of count values, in which
the threshold setting section makes a change to increase the first threshold in a case where the first threshold has not reached a predetermined threshold, and
the subtraction processor performs the subtraction processing in a case where the first threshold has reached the predetermined threshold.
   (11)

The photodetection device according to (10), in which the threshold setting section makes a change to increase the first threshold in a case where all of the plurality of count values have reached a second threshold.

(12)

The photodetection device according to (11), in which the threshold setting section further makes a change to increase the second threshold in a case where all of the plurality of count values have reached the second threshold.

(13)

The photodetection device according to (10), in which the threshold setting section makes a change to increase the first threshold on the basis of the count values of one or more predetermined counters of the plurality of first counters.

(14)

The photodetection device according to any one of (2) to (13), further including a first processor that subtracts a smallest value among the plurality of count values from the plurality of count values after the stop processor stops the count processing in the plurality of first counters.

(15)

The photodetection device according to any one of (2) to (14), further including a second counter that counts number of times the subtraction processing has been performed.

(16)

The photodetection device according to (15), further including a second processor that calculates a photodetection timing on the basis of the plurality of count values after the stop processor stops the count processing in the plurality of first counters, and corrects the photodetection timing on the basis of a count value of the second counter.

(17)

The photodetection device according to (15) or (16), further including a detector that detects a stop timing at which the stop processor stops the count processing in the plurality of first counters.

(18)

The photodetection device according to (17), in which the detector includes a third counter that measures time from when the plurality of first counters starts the count processing to when the stop processor stops the count processing.

(19)

The photodetection device according to (17), in which the detector includes a third counter that measures time from when the stop processor stops the count processing to a subsequent predetermined timing.

(20)

The photodetection device according to (17), further including a code generator that generates a time code, in which
the detector includes a latch circuit that latches the time code at a timing at which the stop processor stops the count processing.
   (21)

The photodetection device according to any one of (17) to (20), further including a third processor that corrects count values of the plurality of first counters on the basis of a count value of the second counter and the stop timing.

(22)

The photodetection device according to any one of (1) to (21), in which
a divider is provided,
the one or more light-receiving sections include one light-receiving section,
the divider distributes the pulse signal generated by the light-receiving section to the plurality of first counters in a time division manner, and
each of the plurality of first counters performs the count processing on the basis of a distributed signal.
   (23)

The photodetection device according to any one of (1) to (21), in which
an adder and a divider are provided,
the one or more light-receiving sections include a plurality of light-receiving sections,
the adder generates an addition pulse signal by performing addition processing on the basis of a plurality of the pulse signals generated by the plurality of light-receiving sections,
the divider distributes the addition pulse signal to the plurality of first counters in a time division manner, and
the plurality of first counters performs the count processing on the basis of a distributed signal.
   (24)

The photodetection device according to any one of (1) to (21), in which
the one or more light-receiving sections include a plurality of light-receiving sections provided corresponding to the plurality of first counters, and
each of the plurality of first counters performs the count processing on the basis of the pulse signal generated by a corresponding light-receiving section of the plurality of light-receiving sections.
   (25)

The photodetection device according to any one of (1) to (24), in which
a plurality of photodetection units is provided, the plurality of photodetection units being arranged side by side in a first direction and a second direction, and
each of the plurality of photodetection units includes the one or plurality of light-receiving sections, the plurality of first counters, and the subtraction processor.
   (26)

The photodetection device according to any one of (1) to (25), in which
the one or plurality of light-receiving sections each includes a pulse generation circuit that is coupled to the light-receiving element and generates the pulse signal,
the light-receiving element is provided on a first semiconductor substrate, and
the pulse generation circuit is provided on a second semiconductor substrate bonded to the first semiconductor substrate.
   (27)

A photodetection device including:
one or a plurality of light-receiving sections that each includes a light-receiving element, and generates a pulse signal including a pulse corresponding to a result of light reception by the light-receiving element;
a plurality of first counters that each performs count processing on the basis of one or a plurality of the pulse signals generated by the one or plurality of light-receiving sections, thereby generating a plurality of count values;
a stop processor that stops the count processing in the plurality of first counters in a case where one or more count values of the plurality of count values have reached a first threshold; and
a threshold setting section that makes a change to increase the first threshold on the basis of one or more count values of the plurality of count values.
   (28)

The photodetection device according to (27), in which the threshold setting section makes a change to increase the first threshold in a case where all of the plurality of count values have reached a second threshold.

(29)

The photodetection device according to (28), in which the threshold setting section further makes a change to increase the second threshold in a case where all of the plurality of count values have reached the second threshold.

(30)

The photodetection device according to (27), in which the threshold setting section makes a change to increase the first threshold on the basis of the count values of one or more predetermined first counters of the plurality of first counters.

(31)

The photodetection device according to any one of (27) to (30), further including a first processor that subtracts a smallest value among the plurality of count values from the plurality of count values after the stop processor stops the count processing in the plurality of first counters.

(32)

The photodetection device according to any one of (27) to (31), in which
a divider is provided,
the one or more light-receiving sections include one light-receiving section,
the divider distributes the pulse signal generated by the light-receiving section to the plurality of first counters in a time division manner, and
each of the plurality of first counters performs the count processing on the basis of a distributed signal.
   (33)

The photodetection device according to any one of (27) to (31), in which
an adder and a divider are provided,
the one or more light-receiving sections include a plurality of light-receiving sections,
the adder generates an addition pulse signal by performing addition processing on the basis of a plurality of the pulse signals generated by the plurality of light-receiving sections,
the divider distributes the addition pulse signal to the plurality of first counters in a time division manner, and
the plurality of first counters performs the count processing on the basis of a distributed signal.
   (34)

The photodetection device according to any one of (27) to (31), in which
the one or more light-receiving sections include a plurality of light-receiving sections provided corresponding to the plurality of first counters, and
each of the plurality of first counters performs the count processing on the basis of the pulse signal generated by a corresponding light-receiving section of the plurality of light-receiving sections.
   (35)

The photodetection device according to any one of (27) to (34), in which
a plurality of photodetection units is provided, the plurality of photodetection units being arranged side by side in a first direction and a second direction, and
each of the plurality of photodetection units includes the one or plurality of light-receiving sections, the plurality of first counters, the stop processor, and the threshold setting section.
   (36)

The photodetection device according to any one of (27) to (35), in which
the one or plurality of light-receiving sections each includes a pulse generation circuit that is coupled to the light-receiving element and generates the pulse signal,
the light-receiving element is provided on a first semiconductor substrate, and
the pulse generation circuit is provided on a second semiconductor substrate bonded to the first semiconductor substrate.
   (37)

A photodetection system including:
a light-emitting section that emits light; and
a light-emitting section that emits light; and
a photodetector that detects light reflected by a detection object of the light emitted from the light-emitting section, in which
the photodetector includes
one or a plurality of light-receiving sections that each includes a light-receiving element, and generates a pulse signal including a pulse corresponding to a result of light reception by the light-receiving element,
a plurality of first counters that each performs count processing on the basis of one or a plurality of the pulse signals generated by the one or plurality of light-receiving sections, thereby generating a plurality of count values, and
a subtraction processor that performs subtraction processing for subtracting a predetermined value from each of the plurality of count values, on the basis of one or more count values of the plurality of count values.
   (38)

A photodetection system including:
a light-emitting section that emits light; and
a photodetector that detects light reflected by a detection object of the light emitted from the light-emitting section, in which
the photodetector includes
one or a plurality of light-receiving sections that each includes a light-receiving element, and generates a pulse signal including a pulse corresponding to a result of light reception by the light-receiving element,
a plurality of first counters that each performs count processing on the basis of one or a plurality of the pulse signals generated by the one or plurality of light-receiving sections, thereby generating a plurality of count values,
a stop processor that stops the count processing in the plurality of first counters in a case where one or more count values of the plurality of count values have reached a first threshold, and
a threshold setting section that makes a change to increase the first threshold on the basis of one or more count values of the plurality of count values.

This application claims the priority on the basis of Japanese Patent Application No. 2020-202130 filed on Dec. 4, 2020 with Japan Patent Office, the entire contents of which are incorporated in this application by reference.

It should be understood by those skilled in the art that various modifications, combinations, sub-combinations, and alterations may occur depending on design requirements and other factors insofar as they are within the scope of the appended claims or the equivalents thereof.

1. A photodetection device comprising:
one or a plurality of light-receiving sections that each includes a light-receiving element, and generates a pulse signal including a pulse corresponding to a result of light reception by the light-receiving element;
a plurality of first counters that each performs count processing on a basis of one or a plurality of the pulse signals generated by the one or plurality of light-receiving sections, thereby generating a plurality of count values; and
a subtraction processor that performs subtraction processing for subtracting a predetermined value from each of the plurality of count values, on a basis of one or more count values of the plurality of count values.

2. The photodetection device according to claim 1, further comprising a stop processor that stops the count processing in the plurality of first counters in a case where one or more count values of the plurality of count values have reached a first threshold.

3. The photodetection device according to claim 2, wherein the subtraction processor performs the subtracting processing in a case where all of the plurality of count values have reached a second threshold.

4. The photodetection device according to claim 2, wherein the subtraction processor performs the subtraction processing in a case where a smallest value among the plurality of count values has reached a second threshold.

5. The photodetection device according to claim 2, wherein the subtraction processor performs the subtraction processing on a basis of the count values of one or more predetermined first counters of the plurality of first counters.

6. The photodetection device according to claim 2, wherein the subtraction processor performs the subtraction processing by changing a bit value of a predetermined count bit of a plurality of count bits in each of the plurality of first counters.

7. The photodetection device according to claim 6, wherein the predetermined count bit comprises a most significant bit of the plurality of count bits.

8. The photodetection device according to claim 2, wherein the subtraction processor performs the subtraction processing in a period in which each of the plurality of first counters does not perform the count processing.

9. The photodetection device according to claim 2, wherein the first threshold comprises a largest possible count value taken by the plurality of count values.

10. The photodetection device according to claim 2, further comprising a threshold setting section that makes a change to increase the first threshold, on a basis of one or more count values of the plurality of count values, wherein
the threshold setting section makes a change to increase the first threshold in a case where the first threshold has not reached a predetermined threshold, and
the subtraction processor performs the subtraction processing in a case where the first threshold has reached the predetermined threshold.

11. The photodetection device according to claim 10, wherein the threshold setting section makes a change to increase the first threshold in a case where all of the plurality of count values have reached a second threshold.

12. The photodetection device according to claim 11, wherein the threshold setting section further makes a change to increase the second threshold in a case where all of the plurality of count values have reached the second threshold.

13. The photodetection device according to claim 10, wherein the threshold setting section makes a change to increase the first threshold on a basis of the count values of one or more predetermined counters of the plurality of first counters.

14. The photodetection device according to claim 2, further comprising a first processor that subtracts a smallest value among the plurality of count values from the plurality of count values after the stop processor stops the count processing in the plurality of first counters.

15. The photodetection device according to claim 2, further comprising a second counter that counts number of times the subtraction processing has been performed.

16. The photodetection device according to claim 15, further comprising a second processor that calculates a photodetection timing on a basis of the plurality of count values after the stop processor stops the count processing in the plurality of first counters, and corrects the photodetection timing on a basis of a count value of the second counter.

17. The photodetection device according to claim 15, further comprising a detector that detects a stop timing at which the stop processor stops the count processing in the plurality of first counters.

18. The photodetection device according to claim 17, wherein the detector includes a third counter that measures time from when the plurality of first counters starts the count processing to when the stop processor stops the count processing.

19. The photodetection device according to claim 17, wherein the detector includes a third counter that measures time from when the stop processor stops the count processing to a subsequent predetermined timing.

20. The photodetection device according to claim 17, further comprising a code generator that generates a time code, wherein
the detector includes a latch circuit that latches the time code at a timing at which the stop processor stops the count processing.

21. The photodetection device according to claim 17, further comprising a third processor that corrects count values of the plurality of first counters on a basis of a count value of the second counter and the stop timing.

22. The photodetection device according to claim 1, wherein
a divider is provided,
the one or more light-receiving sections include one light-receiving section,
the divider distributes the pulse signal generated by the light-receiving section to the plurality of first counters in a time division manner, and
each of the plurality of first counters performs the count processing on a basis of a distributed signal.

23. The photodetection device according to claim 1, wherein
an adder and a divider are provided,
the one or more light-receiving sections include a plurality of light-receiving sections,
the adder generates an addition pulse signal by performing addition processing on a basis of a plurality of the pulse signals generated by the plurality of light-receiving sections,
the divider distributes the addition pulse signal to the plurality of first counters in a time division manner, and
the plurality of first counters performs the count processing on a basis of a distributed signal.

24. The photodetection device according to claim 1, wherein
the one or more light-receiving sections include a plurality of light-receiving sections provided corresponding to the plurality of first counters, and
each of the plurality of first counters performs the count processing on a basis of the pulse signal generated by a corresponding light-receiving section of the plurality of light-receiving sections.

25. The photodetection device according to claim 1, wherein
a plurality of photodetection units is provided, the plurality of photodetection units being arranged side by side in a first direction and a second direction, and
each of the plurality of photodetection units includes the one or plurality of light-receiving sections, the plurality of first counters, and the subtraction processor.

26. The photodetection device according to claim 1, wherein
the one or plurality of light-receiving sections each includes a pulse generation circuit that is coupled to the light-receiving element and generates the pulse signal,
the light-receiving element is provided on a first semiconductor substrate, and
the pulse generation circuit is provided on a second semiconductor substrate bonded to the first semiconductor substrate.

27. A photodetection device comprising:
one or a plurality of light-receiving sections that each includes a light-receiving element, and generates a pulse signal including a pulse corresponding to a result of light reception by the light-receiving element;
a plurality of first counters that each performs count processing on a basis of one or a plurality of the pulse signals generated by the one or plurality of light-receiving sections, thereby generating a plurality of count values;
a stop processor that stops the count processing in the plurality of first counters in a case where one or more count values of the plurality of count values have reached a first threshold; and
a threshold setting section that makes a change to increase the first threshold on a basis of one or more count values of the plurality of count values.

28. The photodetection device according to claim 27, wherein the threshold setting section makes a change to increase the first threshold in a case where all of the plurality of count values have reached a second threshold.

29. The photodetection device according to claim 28, wherein the threshold setting section further makes a change to increase the second threshold in a case where all of the plurality of count values have reached the second threshold.

30. The photodetection device according to claim 27, wherein the threshold setting section makes a change to increase the first threshold on a basis of the count values of one or more predetermined first counters of the plurality of first counters.

31. The photodetection device according to claim 27, further comprising a first processor that subtracts a smallest value among the plurality of count values from the plurality of count values after the stop processor stops the count processing in the plurality of first counters.

32. The photodetection device according to claim 27, wherein
a divider is provided,
the one or more light-receiving sections include one light-receiving section,
the divider distributes the pulse signal generated by the light-receiving section to the plurality of first counters in a time division manner, and
each of the plurality of first counters performs the count processing on a basis of a distributed signal.

33. The photodetection device according to claim 27, wherein
an adder and a divider are provided,
the one or more light-receiving sections include a plurality of light-receiving sections,
the adder generates an addition pulse signal by performing addition processing on a basis of a plurality of the pulse signals generated by the plurality of light-receiving sections,
the divider distributes the addition pulse signal to the plurality of first counters in a time division manner, and
the plurality of first counters performs the count processing on a basis of a distributed signal.

34. The photodetection device according to claim 27, wherein
the one or more light-receiving sections include a plurality of light-receiving sections provided corresponding to the plurality of first counters, and
each of the plurality of first counters performs the count processing on a basis of the pulse signal generated by a corresponding light-receiving section of the plurality of light-receiving sections.

35. The photodetection device according to claim 27, wherein
a plurality of photodetection units is provided, the plurality of photodetection units being arranged side by side in a first direction and a second direction, and
each of the plurality of photodetection units includes the one or plurality of light-receiving sections, the plurality of first counters, the stop processor, and the threshold setting section.

36. The photodetection device according to claim 27, wherein
the one or plurality of light-receiving sections each includes a pulse generation circuit that is coupled to the light-receiving element and generates the pulse signal,
the light-receiving element is provided on a first semiconductor substrate, and
the pulse generation circuit is provided on a second semiconductor substrate bonded to the first semiconductor substrate.

37. A photodetection system comprising:
a light-emitting section that emits light; and
a photodetector that detects light reflected by a detection object of the light emitted from the light-emitting section, wherein
the photodetector includes
one or a plurality of light-receiving sections that each includes a light-receiving element, and generates a pulse signal including a pulse corresponding to a result of light reception by the light-receiving element,
a plurality of first counters that each performs count processing on a basis of one or a plurality of the pulse signals generated by the one or plurality of light-receiving sections, thereby generating a plurality of count values, and
a subtraction processor that performs subtraction processing for subtracting a predetermined value from each of the plurality of count values, on a basis of one or more count values of the plurality of count values.

38. A photodetection system comprising:
a light-emitting section that emits light; and
a photodetector that detects light reflected by a detection object of the light emitted from the light-emitting section, wherein
the photodetector includes
one or a plurality of light-receiving sections that each includes a light-receiving element, and generates a pulse signal including a pulse corresponding to a result of light reception by the light-receiving element,
a plurality of first counters that each performs count processing on a basis of one or a plurality of the pulse signals generated by the one or plurality of light-receiving sections, thereby generating a plurality of count values,
a stop processor that stops the count processing in the plurality of first counters in a case where one or more count values of the plurality of count values have reached a first threshold, and
a threshold setting section that makes a change to increase the first threshold on a basis of one or more count values of the plurality of count values.
